(19) United States
(12) Patent Application Publication
(10) Pub. No.: US 2005/0193206 A1
(43) Pub. Date: Sep. 1, 2005

(54) Digital watermarking system using a cryptographic key

(76) Inventors: Akiomi Kunisa, Tokyo (JP); Yasuaki Inoue, Daito City (JP)

Correspondence Address: MCDERMOTT WILL & EMERY LLP, 600 13TH STREET, N.W., WASHINGTON, DC, 20005-3096, US

(21) Appl. No.: 11/059,316

(22) Filed: Feb. 17, 2005

(30) Foreign Application Priority Data
Feb. 17, 2004 (JP) 2004-040542

(51) Int. Cl. H04L 9/00

(52) U.S. Cl. 713/176

(57) ABSTRACT

A watermark embedder embeds a cryptographic key as a digital watermark into input host data and thereby generates key-embedded host data, and then provides it to a hash generator and a signature attacher. A hash generator generates a hash by putting the key-embedded host data into a one-way function, and provides the hash to an encryptor. The encryptor encrypts hash generated by the hash generator with the cryptographic key and thereby generates a digital signature. The signature attacher attaches the digital signature generated by the encryptor to the key-embedded host data generated by the watermark embedder, and outputs the signature-attached key-embedded host data.

### BACKGROUND OF THE INVENTION

1. Field of the Invention

The present invention relates to a digital watermarking technology, and it particularly relates to an apparatus and method for embedding and extracting a cryptographic key as a digital watermark.

2. Description of the Related Art

The number of Internet users has rapidly increased in recent years and we are now entering the age of the broadband, or a new stage in the utilization of the Internet. Since communication bandwidth has greatly expanded in broadband communication, the distribution of items containing large bodies of data such as audio, still image, and video can be enjoyed with ease. When the distribution of such digital items becomes popular, a highly efficient method protecting the copyright of their contents will be required.

In the present situation, the copyright is not protected well so that users can easily copy such contents distributed via the Internet. Therefore, technology for embedding information on the originator of the content and the user into the content as a digital watermark has been developed. By using this watermarking technology, it becomes possible to extract the digital watermark from the content distributed via the network, and thereby detect an illegal use and track the distribution route of an illegal copy.

Moreover, as a content authentication technology, there is a method for attaching a digital signature to the content, and any malicious attack on the content can be detected by using digest data briefly representing the characteristics of the content as the digital signature.

FIG. 1 shows a structure of a conventional tamper detection system. An encryption apparatus 300 attaches a digital signature s encrypted with a cryptographic key K to input host data P so as to generate signature-attached host data P+s. A decryption apparatus 310 takes a digital signature s′ out of input signature-attached host data P′+s′ and decrypts the digital signature s′ with the cryptographic key K, and thereby detects whether there is any tampering to the host data P′. A key management database server 320 obtains the cryptographic key K used in the encryption apparatus 300 via a network 330 and manages the cryptographic key K as an entry in the data base, and also distributes the cryptographic key K on demand to the decryption apparatus 310 via the network 330.

In the encryption apparatus 300, a hash generator 10 generates a hash h by putting the host data P into a one-way function, and provides the generated hash h to an encryptor 12. The encryptor 12 encrypts the hash h with the cryptographic key K so as to generate the digital signature s and provides the generated digital signature s to a signature attacher 14. The signature attacher 14 attaches the digital signature s to the host data P and outputs the signature-attached host data P+s.

In the decryption apparatus 310, a signature detacher 20 takes the host data P′ and the digital signature s′ separately out of the signature-attached host data P′+s′, and then provides the host data P′ to a hash generator 24 and the digital signature s′ to a decryptor 22. The decryptor 22 obtains a hash h′, which is the data before the digital signature s′ is encrypted, by decrypting the digital signature s′ with the cryptographic key K. On the other hand, the hash generator 24 generates a hash r for verification by putting the host data P′ into the same one-way function as used by the hash generator 10 in the encryption apparatus 300. The comparator 26 compares the hash h′ decrypted by the decryptor 22 with the verification hash r generated by the hash generator 24 and then outputs a verification result concerning whether there is any tampering to the host data P′.

Reference (1) discloses a technology for preventing an illegal copy of a moving image, by which each frame of the moving image is encrypted, and a cryptographic key for decrypting each frame is embedded, as a digital watermark, into a frame just before the frame to be decrypted.

In the above-mentioned tamper detection system that uses the digital signature, the cryptographic key should be distributed to the decryption apparatus 310 and the management of the cryptographic key is necessary. Moreover, it is necessary to distribute the cryptographic key to the decrypting apparatus 310 in a secure way. The security can be improved by frequently changing the cryptographic key for each content, however, the management of the cryptographic key becomes complicated.

Even though a series of frames such as a moving image is a target for the tamper detection, the technology disclosed in Reference (1), by which the cryptographic key for decrypting one frame is embedded as a digital watermark into another frame, cannot complete the tamper detection with only a single frame, because the key cannot be hidden into the frame to be detected. Therefore, this technology cannot be applied to a still image.

Related Art List:

(1) Japanese Patent Application Laid-Open 2002-232412

### SUMMARY OF THE INVENTION

The present invention has been made based on these considerations, and an object thereof is to provide a tamper detection technology which does not require the management of the cryptographic key. Another object is to provide a tamper detection technology which can complete tamper detection solely using the data that is an object of tamper prevention.

According to one aspect of the present invention, a digital watermark embedding apparatus is provided. The apparatus comprises: an encrypting unit which encrypts additional data to be attached to original data; a watermark embedding unit which embeds a cryptographic key necessary for decrypting the encrypted additional data into the original data as a digital watermark; and an attaching unit which attaches the encrypted additional data to the original data.

According to another aspect of the present invention, a digital watermark embedding apparatus is also provided. The apparatus comprises: an encrypting unit which encrypts data briefly representing a characteristic of original data so as to generate a digital signature; a watermark embedding unit which embeds a cryptographic key necessary for decrypting the digital signature into the original data as a digital watermark; and a signature attaching unit which attaches the digital signature to the original data. After the cryptographic key is embedded into the original data as a digital watermark, the digital signature may be attached to the key-embedded original data. Conversely, after the digital signature is attached to the original data, the cryptographic key may be embedded into the original data. Herein, what is meant by attaching the digital signature to the original data includes not only attaching the digital signature to the original data in the form of header or the like, but also embedding the digital signature into the original data as a digital watermark. In the latter case, the digital signature and the cryptographic key are embedded as a double watermark into the original data. The order of embedding the digital signature and the cryptographic key into the original data is arbitrary.

The original data herein is data which the digital signature is to be attached to and the digital watermark is to be embedded into. The original data is, for instance, content data such as a still image, a moving image, an audio, or the like. The data briefly representing a characteristic of the original data is, for instance, digest data of the original data, namely data of a comparatively short fixed length that represents a characteristic of the original data.

According to still another aspect of the present invention, a digital watermark extracting apparatus is provided. The apparatus comprises: a detaching unit which takes original data and additional data separately out of input data; a watermark extracting unit which extracts a cryptographic key which has been embedded as a digital watermark into the original data; and a decrypting unit which decrypts the additional data with the cryptographic key.

According to still another aspect of the present invention, a digital watermark extracting apparatus is also provided. The apparatus comprises: a signature detaching unit which takes original data and a digital signature separately out of signature-attached data; a watermark extracting unit which extracts a cryptographic key which has been embedded as a digital watermark into the original data; and a decrypting unit which decrypts the digital signature with the cryptographic key. Herein, what is meant by taking original data and a digital signature separately out of signature-attached data includes extracting a digital signature as a digital watermark from the data into which the digital signature has been embedded as a digital watermark. In this case, if the digital signature is embedded by a reversible watermarking scheme, the digital signature is extracted and removed so as to restore the original data that is the data before the digital signature is embedded.

According to still another aspect of the present invention, a digital watermark extracting apparatus is also provided. The apparatus comprising: a signature detaching unit which takes original data and a digital signature separately out of signature-attached data; a watermark extracting unit which extracts a cryptographic key which has been embedded as a digital watermark into the original data; an encrypting unit which encrypts data briefly representing a characteristic of the original data with the cryptographic key so as to generate a digital signature for verification; and a comparing unit which compares the digital signature taken out by the signature detaching unit with the digital signature for the verification generated by the encrypting unit.

According to still another aspect of the present invention, a digital watermark embedding apparatus is also provided. The apparatus comprises: an encrypting unit which encrypts data briefly representing a characteristic of each original data in a series of input original data so as to generate a digital signature; a watermark embedding unit which embeds into the original data a cryptographic key necessary for decrypting the digital signature as a digital watermark; a signature attaching unit which attaches the digital signature to the original data; and a holding unit which holds the digital signature generated by the encrypting unit, wherein the encrypting unit generates the digital signature for the original data currently processed in such a manner that the generated digital signature depends on the digital signature for the original data formerly processed which has been held in the holding unit.

According to still another aspect of the present invention, a digital watermark embedding apparatus is also provided. The apparatus comprises: an encrypting unit which encrypts data briefly representing a characteristic of each original data in a series of input original data so as to generate a digital signature; a watermark embedding unit which embeds into the original data a cryptographic key necessary for decrypting the digital signature as a digital watermark; a signature attaching unit which attaches the digital signature to the original data; a first holding unit which holds the digital signature generated by the encrypting unit; and a second holding unit which holds the original data in which the digital watermark has been embedded by the watermark embedding unit, wherein the encrypting unit generates the digital signature for the original data currently processed in such a manner that the generated digital signature depends on the digital signature for the original data formerly processed which has been held in the first holding unit, and the signature attaching unit attaches the digital signature generated for the original data currently processed to the original data formerly processed which has been held in the second holding unit.

According to still another aspect of the present invention, a digital watermark extracting apparatus is also provided. The apparatus comprises: a signature detaching unit which receives a series of input signature-attached data and takes original data and a digital signature separately out of each signature-attached data; a watermark extracting unit which extracts a cryptographic key that has been embedded as a digital watermark into the original data; a decrypting unit which decrypts the digital signature, which has been taken out by the signature detaching unit, with the cryptographic key; a generating unit which generates data briefly representing a characteristic of the original data by putting the original data into a one-way function; and a holding unit which holds the digital signature taken out by the signature detaching unit, wherein the generating unit generates the data briefly representing the original data currently processed in such a manner that the generated data depends on the digital signature for the original data formerly processed which has been held in the holding unit.

According to still another aspect of the present invention, a digital watermark extracting apparatus is also provided. The apparatus comprising: a signature detaching unit which receives a series of input signature-attached data and takes original data and a digital signature separately out of each signature-attached data; a watermark extracting unit which extracts a cryptographic key that has been embedded as a digital watermark into the original data; an encrypting unit which encrypts data briefly representing a characteristic of the original data with a cryptographic key so as to generate a digital signature for verification; a comparing unit which compares the digital signature taken out by the signature detaching unit with the digital signature for the verification generated by the encrypting unit; and a holding unit which holds the digital signature taken out by the signature detaching unit, wherein the encrypting unit generates the digital signature for the verification for the original data currently processed in such a manner that the generated digital signature depends on the digital signature for the original data formerly processed which has been held in the holding unit.

According to still another aspect of the present invention, a data structure of a self-decryptable type of data is provided. This data structure comprises original data with a header attached thereto, wherein the header of the original data contains a digital signature obtained by encrypting data briefly representing a characteristic of the original data, and a cryptographic key necessary for decrypting the digital signature is embedded as a digital watermark into the original data.

According to still another aspect of the present invention, a data structure of a self-decryptable type of data is also provided. The data structure comprises original data, wherein a digital signature obtained by encrypting data briefly representing a characteristic of the original data and a cryptographic key necessary for decrypting the digital signature are embedded as a double watermark into the original data.

According to still another aspect of the present invention, a digital watermark embedding method is provided. The method comprises attaching to the original data a digital signature obtained by encrypting data briefly representing a characteristic of original data, and embedding into the original data a cryptographic key necessary for decrypting the digital signature as a digital watermark.

According to still another aspect of the present invention, a digital watermark extracting method is provided. The method comprises extracting a cryptographic key which has been embedded as a digital watermark into original data, and decrypting a digital signature attached to the original data with the cryptographic key so as to verify the digital signature.

Moreover, any arbitrary replacement or substitution of the above-described structural components and the steps, expressions replaced or substituted in part or whole between a method and an apparatus as well as addition thereof, and expressions changed to a system, a computer program, a data structure, a storage medium, a transmission medium or the like are all effective as and are encompassed by the present invention.

This summary of the invention does not necessarily describe all necessary features, so that the invention may also be a sub-combination of these described features.

### BRIEF DESCRIPTION OF THE DRAWINGS

FIG. 1 shows a structure of a conventional tamper detection system.

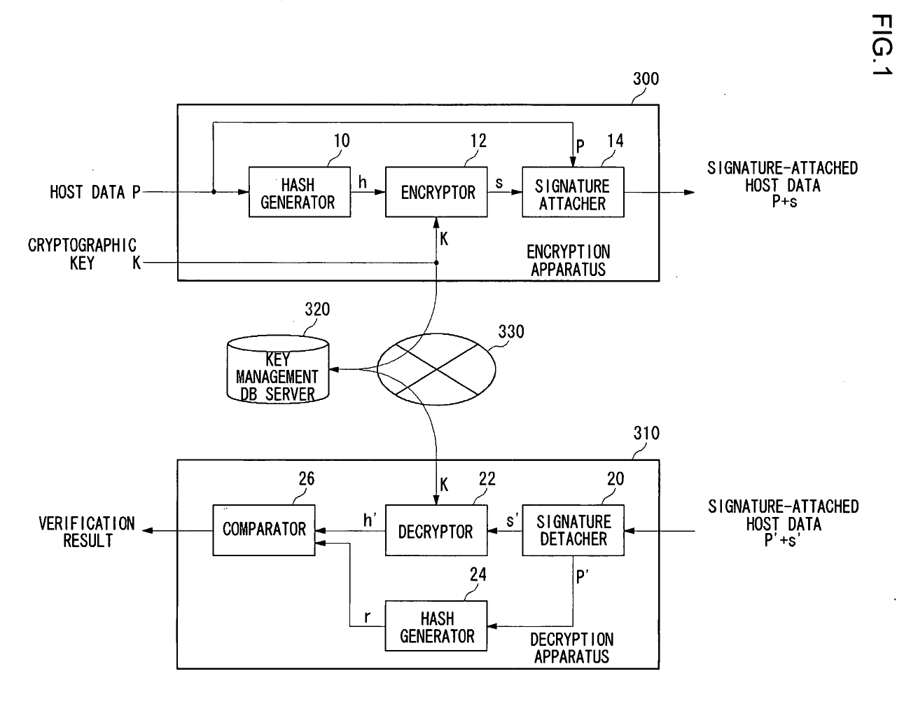

FIG. 2 shows a structure of a watermark embedding apparatus according to Embodiment 1.

FIG. 3 illustrates how host data is processed by the watermark embedding apparatus of FIG. 2.

FIG. 4 shows a structure of a watermark extracting apparatus according to Embodiment 1.

FIG. 5 illustrates how signature-attached key-embedded host data is processed by the watermark extracting apparatus of FIG. 4.

FIG. 6 shows a structure of a watermark extracting apparatus according to Embodiment 2.

FIG. 7 illustrates how signature-attached key-embedded host data is processed by the watermark extracting apparatus of FIG. 6.

FIG. 8 shows a structure of a watermark embedding apparatus according to Embodiment 3.

FIG. 9 illustrates how host data is processed by the watermark embedding apparatus of FIG. 8.

FIG. 10 shows a structure of a watermark extracting apparatus according to Embodiment 3.

FIG. 11 illustrates how signature-attached key-embedded host data is processed by the watermark extracting apparatus of FIG. 10.

FIG. 12 shows a structure of a watermark embedding apparatus according to Embodiment 4.

FIG. 13 illustrates how host data is processed by the watermark embedding apparatus of FIG. 12.

FIG. 14 shows a structure of a watermark extracting apparatus according to Embodiment 4.

FIG. 15 illustrates how signature-attached key-embedded host data is processed by the watermark extracting apparatus of FIG. 14.

FIG. 16 shows a structure of another type of a watermark embedding apparatus.

FIG. 17 illustrates how host data is processed by the watermark embedding apparatus of FIG. 16.

FIG. 18 shows a structure of still another type of a watermark embedding apparatus.

FIG. 19 illustrates how host data is processed by the watermark embedding apparatus of FIG. 18.

FIG. 20 shows a structure of still another type of a watermark embedding apparatus.

FIG. 21 illustrates how host data is processed by the watermark embedding apparatus of FIG. 20.

FIG. 22 shows a structure of a watermark embedding apparatus according to Embodiment 5.

FIG. 23 illustrates how host data is processed by the watermark embedding apparatus of FIG. 22.

FIG. 24 shows a structure of a watermark extracting apparatus according to Embodiment 5.

FIG. 25 illustrates how signature-attached key-embedded host data is processed by the watermark extracting apparatus of FIG. 24.

FIG. 26 shows a structure of a watermark embedding apparatus into which an image encoding apparatus is incorporated according to Embodiment 6.

FIG. 27 shows a structure of a watermark extracting apparatus into which an image decoding apparatus 220 is incorporated according to Embodiment 6.

FIG. 28 shows a structure of a watermark embedding apparatus into which an image encoding apparatus is incorporated according to Embodiment 7.

FIG. 29 shows a structure of a watermark extracting apparatus into which an image decoding apparatus is incorporated according to Embodiment 7.

### DETAILED DESCRIPTION OF THE INVENTION

The invention will now be described by reference to the preferred embodiments. This does not intend to limit the scope of the present invention, but to exemplify the invention.

### Embodiment 1

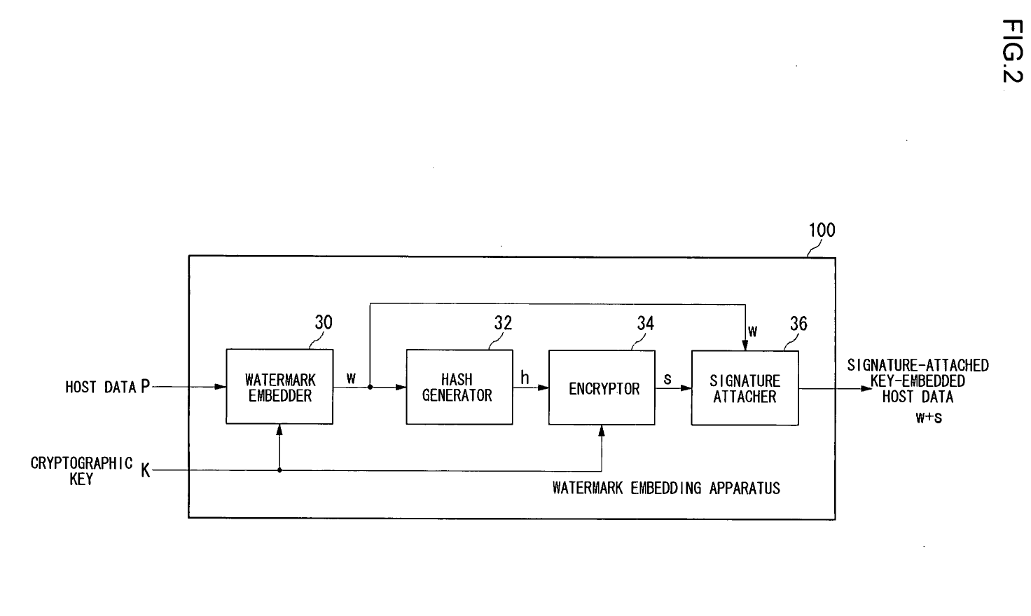

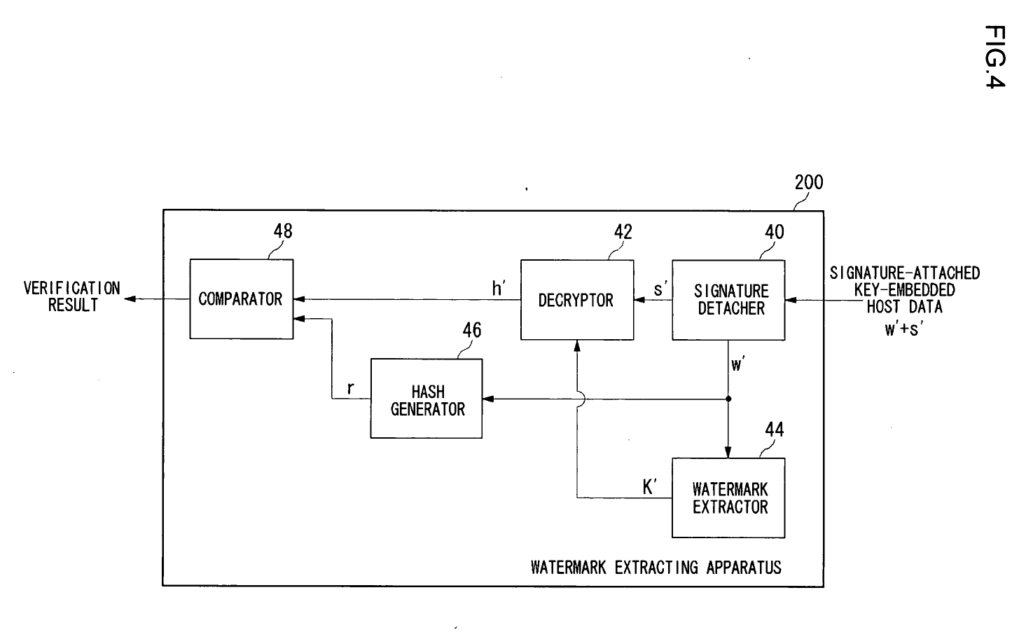

A tamper detection system according to Embodiment 1 includes a watermark embedding apparatus 100 shown in FIG. 2 and a watermark extracting apparatus 200 shown in FIG. 4. These apparatuses may be connected with each other via a network, and the data that the watermark embedding apparatus 100 outputs may be input to the watermark extracting apparatus 200 via the network. Moreover, the tamper detection system may be configured as a server-client system in which the watermark embedding apparatus 100 is a server and the watermark extracting apparatus 200 is a client. Moreover, these apparatuses may be integrated so as to be configured as one apparatus, and the data that the watermark embedding apparatus 100 outputs may be stored in a storage device and the data read from the storage device may be input to the watermark extracting apparatus 200.

FIG. 2 shows a structure of the watermark embedding apparatus 100 according to Embodiment 1. This structure can be realized by hardware, such as a CPU in arbitrary computers, memory and other LSIs, or by software, such as a program or the like loaded in the memory, which has functions for encryption and embedding digital watermarks. In the figure, functions, which are realized by combinations of such hardware and software, are shown by blocks. It should be understood by those skilled in the art that these functional blocks can be realized by various modes such as hardware only, software only or a combination thereof.

Host data P input to the watermark embedding apparatus 100 is original data which a digital signature is to be attached to and a digital watermark is to be embedded into. The host data P are, for instance, media data such as a still image, a moving image, an audio, or the like. In the case of a moving image, the digital signature and the digital watermark may be attached to a unit of frame or a set of frames.

A watermark embedder 30 embeds a cryptographic key K as a digital watermark into the input host data P so as to generate key-embedded host data w and provides it to a hash generator 32 and a signature attacher 36. The hash generator 32 generates a hash h by putting the key-embedded host data w into a one-way function and provides the generated hash h to the encryptor 34.

The one-way function used by the hash generator 32 converts the input value of any length into the output value of a fixed length (it is referred to as a hash value or simply referred to as a hash), and its inverse transform is computationally hard. Specifically, it is easy to calculate a hash h=H(x) for an input x when a one-way function H is given, but it is computationally impossible to find an input x that satisfies H(x)=h when a hash h is given.

In general, the length of the hash h is shorter than that of the input x and the hash h briefly represents the characteristic of the input x. For this reason, the hash might be referred to as digest data. MD5 (Message Digest 5) and SHA (Secure Hash Algorithm) are known as a method for generating the message digest by using a one-way function. Such a message digesting technology can be applied to the hash generator 32 to generate the hash h from the host data P.

The encryptor 34 encrypts the hash h generated by the hash generator 32 with the cryptographic key K and thereby generates a digital signature s. The cryptographic key K used to encrypt the digital signature s is the same one that the watermark embedder 30 has embedded into the host data P as a digital watermark. A signature attacher 36 attaches the digital signature s generated by the encryptor 34 to the key-embedded host data w generated by the watermark embedder 30, and thereby outputs the signature-attached key-embedded host data w+s. For instance, the signature attacher 36 attaches the digital signature s as a header of the key-embedded host data w.

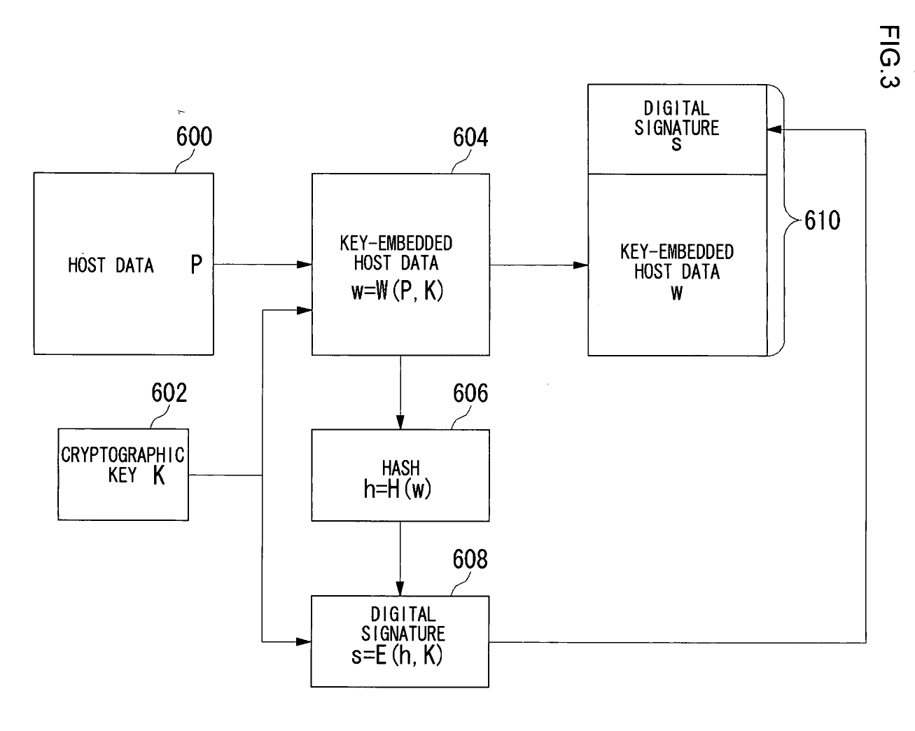

FIG. 3 illustrates how the host data P is processed by the watermark embedding apparatus 100. The watermark embedder 30 converts the host data P (denoted by reference numeral 600) into the key-embedded host data w=W(P,K) (denoted by reference letters 604) according to a watermarking function W based on the cryptographic key K (denoted by reference numeral 602). The hash generator 32 converts the key-embedded host data w into the hash h=H(w) (denoted by reference numeral 606) by using a hash function H. The encryptor 34 converts the hash h into the digital signature s=E(h,K) (denoted by reference numeral 608) by using an encryption function E based on the cryptographic key K. The signature attacher 36 generates the signature-attached key-embedded host data w+s (denoted by reference numeral 610) in which the digital signature s is attached as a header of the key-embedded host data w.

The signature-attached key-embedded host data w+s has a data structure such that the digital signature s is included in a header part thereof and the cryptographic key K for decrypting the digital signature s is embedded as a digital watermark into a data portion thereof. This data is a self-decryptable type of data such that the digital signature is self-decrypted using this data only and the tamper detection can be completed without any external information given.

FIG. 4 shows a structure of the watermark extracting apparatus 200 according to Embodiment 1. This structure can be also realized by hardware, such as a CPU in arbitrary computers, memory and other LSIs, or by software, such as a program or the like loaded in the memory, which has functions for decryption and extracting digital watermarks. In the figure, functions, which are realized by combinations of such hardware and software, are shown by blocks.

A signature detacher 40 takes the key-embedded host data w′ and the digital signature s′ separately out of the signature-attached key-embedded host data w′+s′, and then provides the key-embedded host data w′ to a watermark extractor 44 and a hash generator 46, and the digital signatures s′ to a decryptor 42.

The watermark extractor 44 extracts the cryptographic key K′ which has been embedded as a digital watermark into the key-embedded host data w′, and provides the extracted cryptographic key K′ to the decryptor 42. The decryptor 42 decrypts the digital signature s′ with the cryptographic key K′ and thereby obtains the hash h′ that is the data before the digital signature s′ is encrypted.

On the other hand, the hash generator 46 generates the hash r for verification by putting the key-embedded host data w′ into a one-way function. The one-way function used herein by the hash generator 46 is the same one as used by the hash generator 32 of the watermark embedding apparatus 100. Namely, the hash generator 46 of the watermark extracting apparatus 200 and the hash generator 32 of the watermark embedding apparatus 100 perform the same hash generation process for the input data.

A comparator 48 compares the hash h′ decrypted by the decryptor 42 with the verification hash r generated by the hash generator 46. The comparator 48 judges that there is no tampering to the host data if the two hashes agree and that there is tampering to the host data if the two do not agree, and then outputs the verification result.

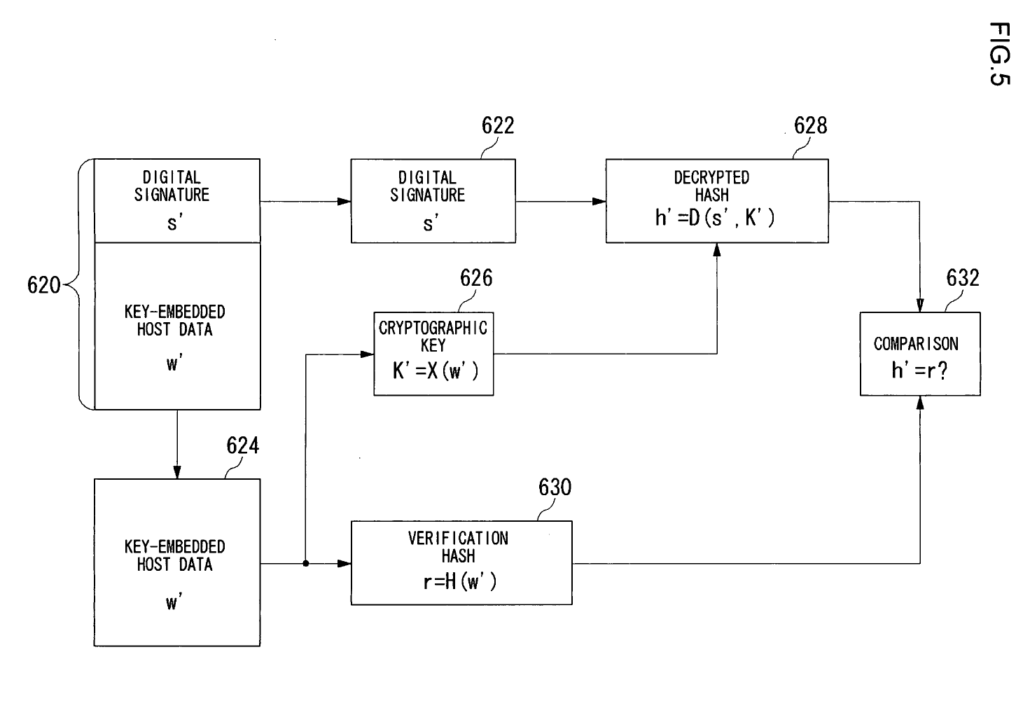

FIG. 5 illustrates how the signature-attached key-embedded host data w′+s′ is processed by the watermark extracting apparatus 200. The signature detacher 40 takes the key-embedded host data w′ (denoted by reference numeral 624) and the digital signatures s′ (denoted by reference numeral 622) separately out of the key-embedded host data w′+s′ (denoted by reference numeral 620). The watermark extractor 44 extracts the cryptographic key K′=X(w′) (denoted by reference numeral 626) from the key-embedded host data w′ by using a watermark extraction function X. The decryptor 42 converts the digital signature s′ into the hash h′=D(s′,K′) (denoted by reference numeral 628) by using a decryption function D based on the cryptographic key K′.

On the other hand, the hash generator 46 converts the key-embedded host data w′ into the verification hash r=H(w′) (denoted by reference numeral 630) by using the hash function H. The comparator 48 compares the decrypted hash h′ with the verification hash r (denoted by reference numeral 632).

In the description given above, the signature attacher 36 in the watermark embedding apparatus 100 may embed the digital signature s as a digital watermark into the key-embedded host data w. In this case, the signature detacher 40 in the watermark extracting apparatus 200 extracts the digital signature s as a digital watermark from the signature-attached key-embedded host data w+s.

Moreover, instead of the digital signature s being embedded into the host data in which the cryptographic key K has been embedded as stated above, the digital signature s might be first embedded into the host data and thereafter the cryptographic key K might be embedded into the host data. In this case, the watermark embedder 30 of FIG. 2 which embeds the cryptographic key K is arranged right after the signature attacher 36. In doubly watermarking, since one watermark is embedded independently of another watermark being embedded, the two watermarks can be extracted in any order. However, if the two watermarks have not been embedded independently, the extraction order thereof should be in the opposite order of the embedding.

According to the tamper detection system in this embodiment described so far, since the cryptographic key used for encrypting the digital signature is embedded into the host data as a digital watermark, the cryptographic key does not need to be managed on a key management server or the like. In addition, since the cryptographic key has been embedded as a digital watermark into the host data and thus concealed, the secrecy of the cryptographic key can be preserved as long as the extraction method of the watermark is not known. Moreover, since the digital signature and the cryptographic key for decrypting the digital signature have been integrated with the host data so as to configure a unified data structure, the host data is a self-decryptable type data that does not need any external input of the key for decryption. Therefore the tamper detection can be completed by using the host data only.

### Embodiment 2

A tamper detection system according to Embodiment 2 also includes a watermark embedding apparatus 100 and a watermark extracting apparatus 200 as in Embodiment 1, but the structure of the watermark extracting apparatus 200 differs from that of Embodiment 1. Since the structure and operation of the watermark embedding apparatus 100 is the same as described in Embodiment 1, the description thereof will be omitted.

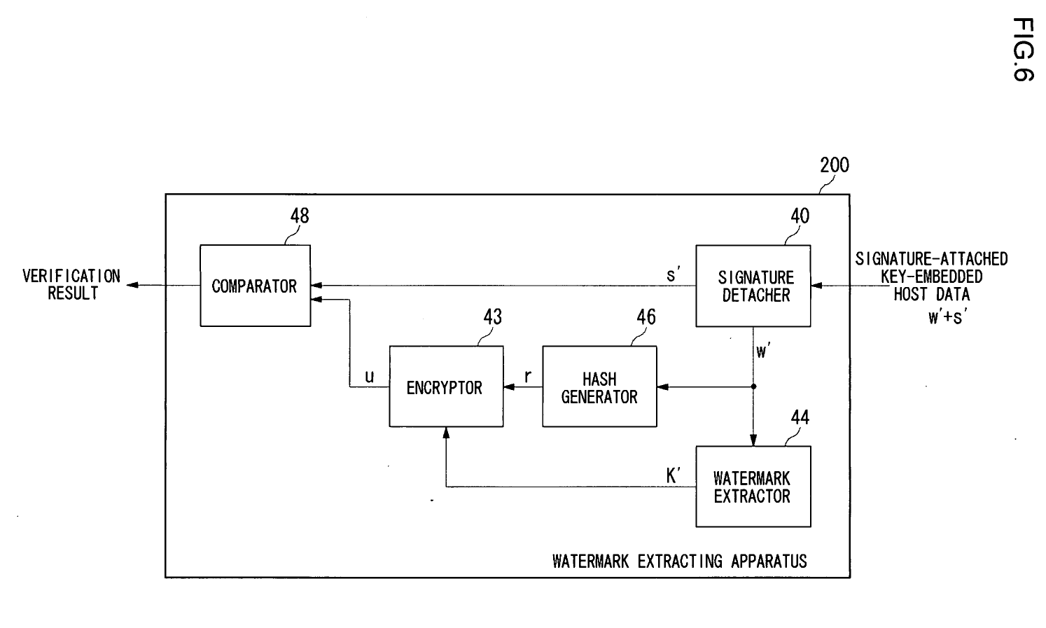

FIG. 6 shows a structure of the watermark extracting apparatus 200 according to Embodiment 2. The signature detacher 40 takes out the key-embedded host data w′ and the digital signature s′ separately out of the signature-attached key-embedded host data w′+s′, and then provides the key-embedded host data w′ to the watermark extractor 44 and the hash generator 46, and the digital signature s′ to the comparator 48.

The watermark extractor 44 extracts the cryptographic key K′ which has been embedded as a digital watermark into the key-embedded host data w′, and then provides the extracted cryptographic key K′ to the encryptor 43. The hash generator 46 generates the verification hash r by putting the key-embedded host data w′ into a one-way function as described in Embodiment 1. The encryptor 43 encrypts the verification hash r, which has been generated by the hash generator 46, with the cryptographic key K′ and thereby generates the digital signature u for verification.

The comparator 48 compares the digital signature s′ taken out by the signature detacher 40 with the verification digital signature generated by the encryptor 43. The comparator 48 judges that there is no tampering to the host data if the two signatures agree and that there is tampering to the host data if the two signatures do not agree, and then outputs the verification result.

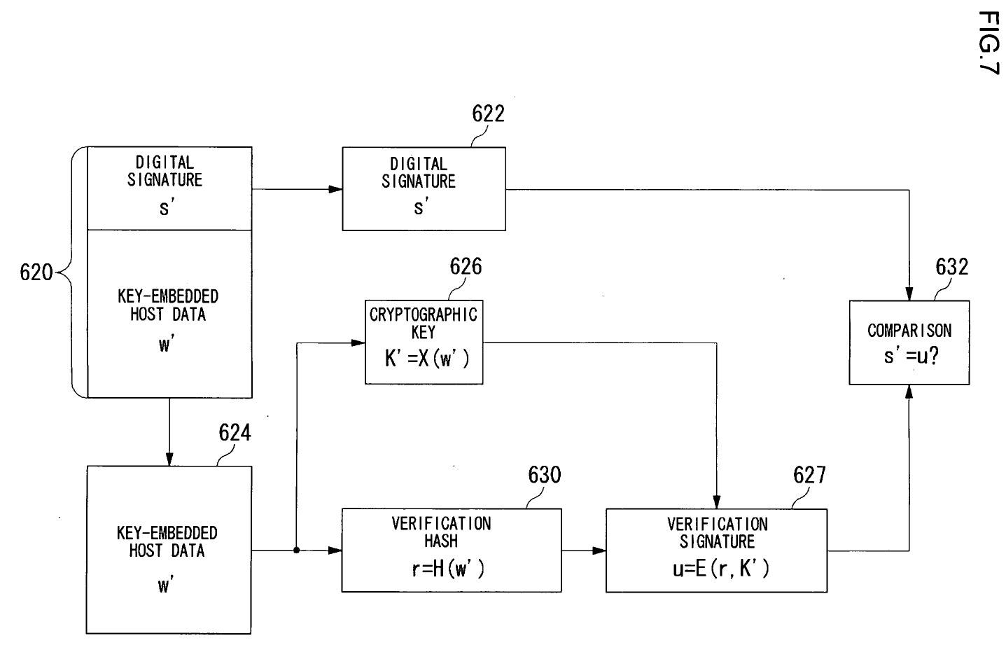

FIG. 7 illustrates how the signature-attached key-embedded host data w′+s′ is processed by the watermark extracting apparatus 200. The signature detacher 40 takes the key-embedded host data w′ (denoted by reference numeral 624) and the digital signatures s′ (denoted by reference numeral 622) separately out of the signature-attached key-embedded host data w′+s′ (denoted by reference numeral 620). The watermark extractor 44 extracts the cryptographic key K′=X(w′) (denoted by reference numeral 626) from the key-embedded host data w′ by using the watermark extraction function X. The hash generator 46 converts the key-embedded host data w′ into the verification hash r=H(w′) (denoted by reference numeral 630) by using the hash function H. The encryptor 43 converts the verification hash r into the verification digital signature u=E(r,K′) (denoted by reference numeral 627) by using an encryption function E based on the cryptographic key K′. The comparator 48 compares the digital signature s′ taken out of the signature-attached key-embedded host data w+s with the verification digital signatures u (reference numeral 632).

In the watermark extracting apparatus 200 according to Embodiment 1, the comparator 48 detects whether there is any tampering by verifying the hash, while in the watermark extracting apparatus 200 according to this embodiment, the comparator 48 collates the encrypted digital signature. For this purpose, the watermark extracting apparatus 200 has an encryptor 43 instead of having the decryptor 42 described in Embodiment 1. The structure and operation of the hash generator 46 and the encryptor 43 in the watermark extracting apparatus 200 are the same as those of the hash generator 32 and the encryptor 34 in the watermark embedding apparatus 100. Therefore, if the watermark embedding apparatus 100 and the watermark extracting apparatus 200 is integrated into one apparatus, the structure of the hash generator and the encryptor can be shared, resulting in the configuration being simplified.

### Embodiment 3

A tamper detection system according to Embodiment 3 also includes a watermark embedding apparatus 100 and a watermark extracting apparatus 200 as in Embodiment 1, but the structure of the watermark embedding apparatus 100 differs from that of Embodiment 1. Except the influence of the watermark upon the hash, the structure and operation of the watermark extracting apparatus 200 is the same as described in Embodiment 1 and the description thereof will be omitted hereinbelow.

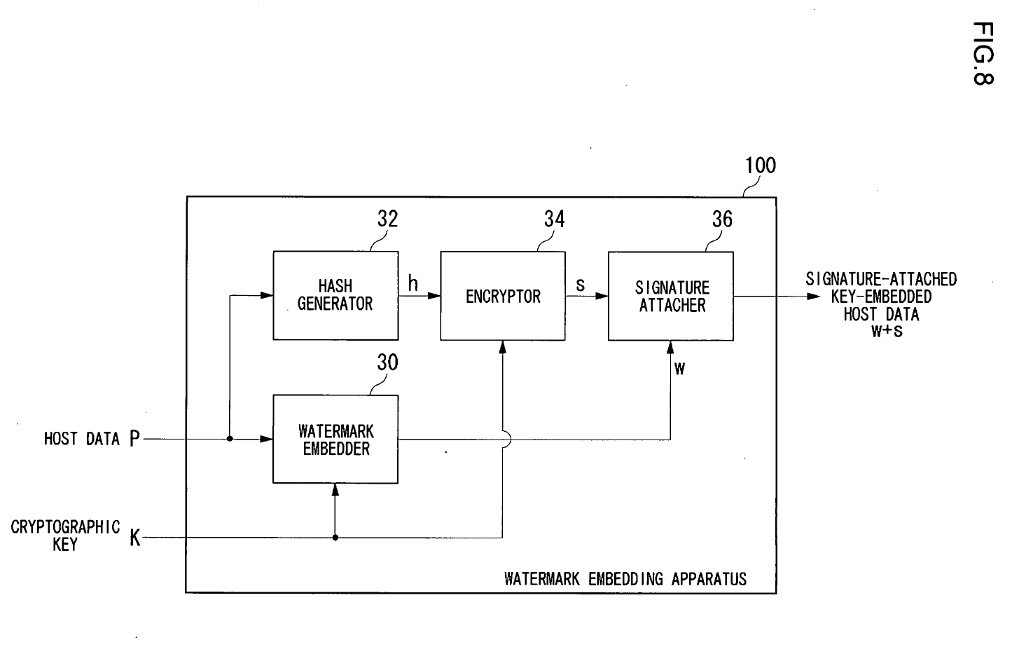

FIG. 8 shows a structure of the watermark embedding apparatus 100 according to Embodiment 3. The watermark embedder 30 embeds the cryptographic key K as a digital watermark into the input host data P to generate the key-embedded host data w and then provides it to the signature attacher 36.

The hash generator 32 generates a hash h by putting the host data P into a one-way function and provides the hash h to the encryptor 34. In Embodiment 1, the hash generator 32 puts into a one-way function the key-embedded host data w in which the cryptographic key K has already been embedded, but it is to be noted that the hash generator 32 in this embodiment puts into a one-way function the host data P in which the cryptographic key K has not been embedded yet.

Thereafter, the encryptor 34 encrypts the hash h, which has been generated by the hash generator 32, with the cryptographic key K and thereby generates the digital signature s as described in Embodiment 1. The signature attacher 36 attaches the digital signature s generated by the encryptor 34 to the key-embedded host data w generated by the watermark embedder 30, and then outputs the signature-attached key embedding host data w+s.

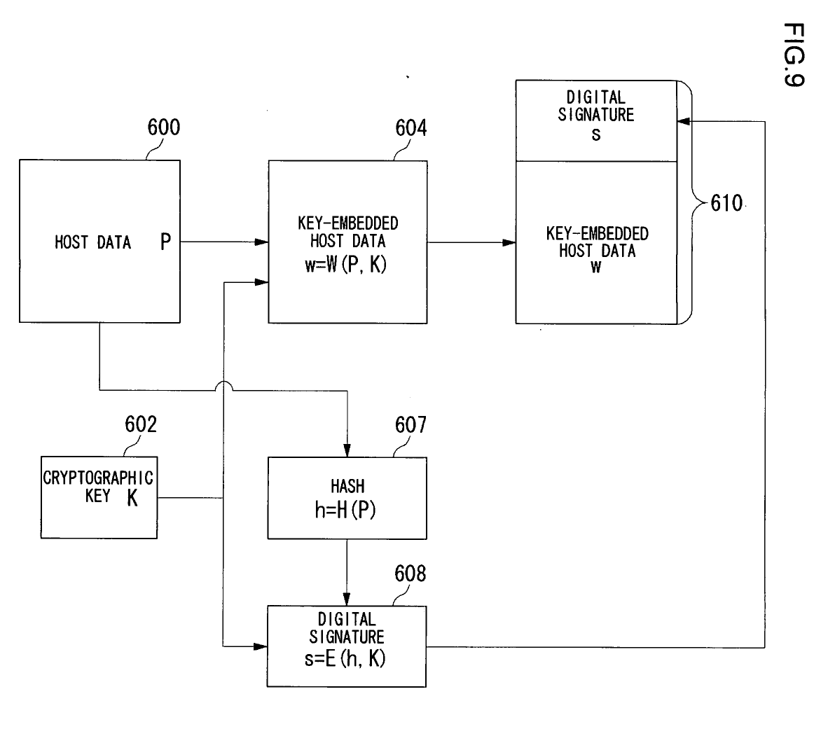

FIG. 9 illustrates how the host data P is processed by the watermark embedding apparatus 100. The watermark embedder 30 converts the host data P (denoted by reference numeral 600) into the key-embedded host data w=W(P,K) (denoted by reference numeral 604) by using the watermark embedding function W based on the cryptographic key K (denoted by reference numeral 602). The hash generator 32 converts the host data P into the hash h=H(P) (denoted by reference numeral 607) by using the hash function H. The encryptor 34 converts the hash h into the digital signature s=E(h,K) (denoted by reference numeral 608) by using the encryption function E based on the cryptographic key K. The signature attacher 36 generates the signature-attached key-embedded host data w+s (denoted by reference numeral 610) in which the digital signature s is provided as a header of the key-embedded host data w.

The watermark extracting apparatus 200 in this embodiment is the same as the watermark extracting apparatus 200 in Embodiment 1 shown in FIG. 4, and the decryptor 42 obtains the hash h′, which is the data before the digital signature s′ is encrypted, by decrypting the digital signature s′ with the cryptographic key K′. On the other hand, the hash generator 46 generates a verification hash r by putting the key-embedded host data w′ into a one-way function.

The hash h′ thus decrypted by the decryptor 42 is digest data generated from host data P, which the cryptographic key K has not been embedded yet, by the hash generator 32 in the watermark embedding apparatus 100, while the verification hash r is digest data generated from the key-embedded host data w′ in which the cryptographic key K has already been embedded. Therefore, the two digest data do not agree in general because of the influence of the watermark. This is because the one-way function, by its nature, produces a significant difference in the output hash data even though there is any slight difference in the input data.

In order to eliminate the influence of the watermark upon the hash, the hash generator 32 in the watermark embedding apparatus 100 generates the hash h from a portion of data which is not subject to the influence of the watermark. For instance, the host data P is divided into one area to be watermarked and another area from which the hash is to be generated, so that the embedding of the cryptographic key K by the watermark embedder 30 and the generating of the hash h by the hash generator 32 should not interfere with each other.

As another method for eliminating the influence of the watermark upon the hash, the host data P is divided into bit planes from the most significant bit (MSB) to the least significant bit (LSB). The watermark embedder 30 embeds the cryptographic key K in a couple of bit planes at the side close to LSB. On the other hand, the hash generator 32 generates the hash h from a couple of bit planes at the side close to MSB, avoiding the couple of bit planes at the side close to the LSB where the cryptographic key K has been embedded. Since the digest data is data briefly representing the characteristics of the host data P, there would be no problem even if the digest data is generated only from the bit planes at the side close to MSB.

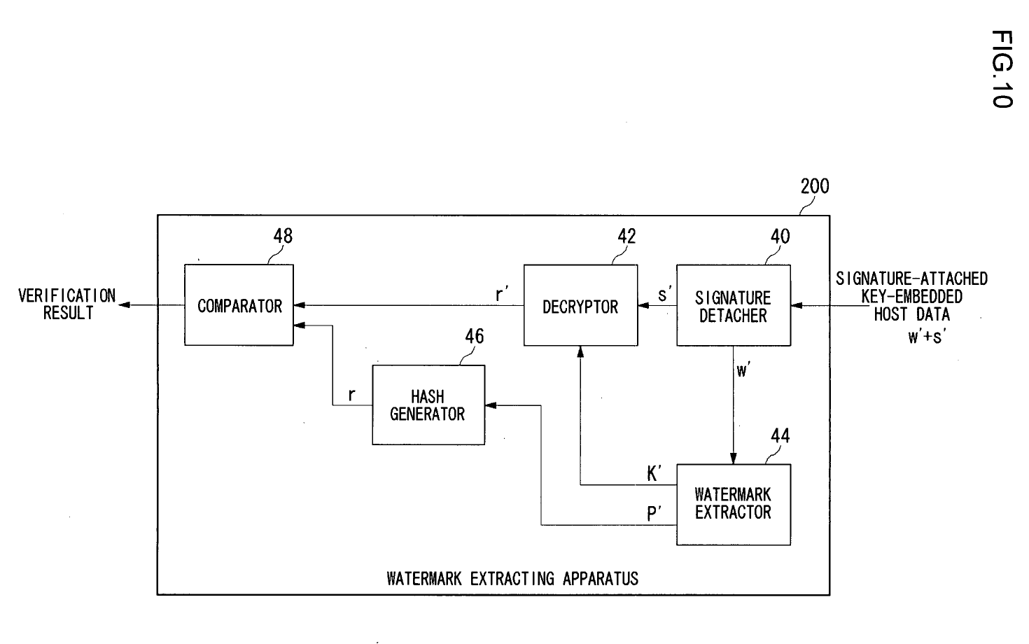

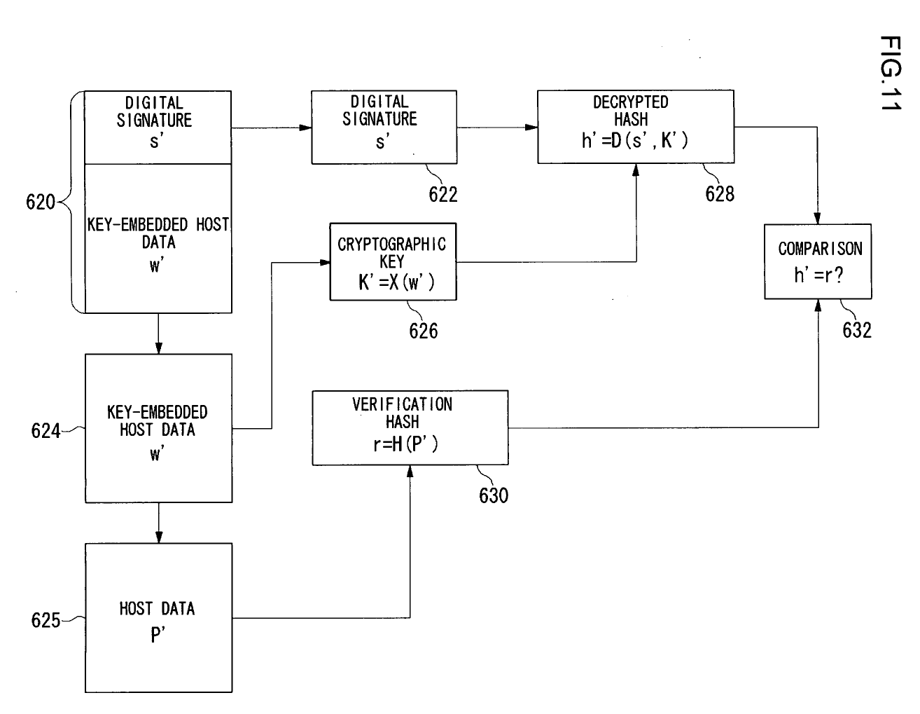

It is to be noted that if the cryptographic key K has been embedded by a reversible watermarking scheme in which the embedded watermark can be removed so as to recover the original state before the watermark has been embedded, the watermark extracting apparatus 200 can generate the hash after eliminating the influence of the watermark. With reference to FIG. 10 and FIG. 11, the structure and operation of the watermark extracting apparatus 200 which employs the reversible watermarking scheme will be now described.

FIG. 10 shows a structure of the watermark extracting apparatus 200 according to Embodiment 3. The signature detacher 40 takes the key-embedded host data w′ and the digital signature s′ separately out of the signature-attached key-embedded host data w′+s′, and then provides the key-embedded host data w′ to the watermark extractor 44 and the digital signature s′ to the decryptor 42.

The watermark extractor 44 extracts the cryptographic key K′ which has been embedded as a digital watermark in the key-embedded host data w′, and removes the cryptographic key K′ from the key-embedded host data w′ so as to restore the host data P′. The watermark extractor 44 provides the extracted cryptographic key K′ to the decryptor 42 and the restored host data P to the hash generator 46.

The decryptor 42 obtains the hash h′, which is the data before the digital signature s′ is encrypted, by decrypting the digital signature s′ with the cryptographic key K′. On the other hand, the hash generator 46 generates a verification hash r by putting the host data P′ into a one-way function.

The comparator 48 compares the hash h′ decrypted by the decryptor 42 with the verification hash r generated by the hash generator 46 and outputs the verification result concerning whether there is any tampering to the host data or not.

FIG. 11 illustrates how the signature-attached key-embedded host data w′+s′ is processed by the watermark extracting apparatus 200. The signature detacher 40 takes the key-embedded host data w′ (denoted by reference numeral 624) and the digital signatures s′ (denoted by reference numeral 622) separately out of the signature-attached key-embedded host data w′+s′ (denoted by reference numeral 620). The watermark extractor 44 extracts the cryptographic key K′=X(w′) (denoted by reference numeral 626) from the key-embedded host data w′ by using the watermark extraction function X, and further removes the cryptographic key K′ from the key-embedded host data w′ so as to restore the host data P′ (denoted by reference numeral 625). The decryptor 42 converts the digital signature s′ into the hash h′=D(s′, K′) (denoted by reference numeral 628) by using the decryption function D based on the cryptographic key K′.

On the other hand, the hash generator 46 converts the restored host data P′ into the verification hash r=H(P′) (denoted by reference numeral 630) by using the hash function H. The comparator 48 compares the decoded hash h′ with the verification hash r (denoted by reference numeral 632).

According to this watermark extracting apparatus 200, the hash h′ decrypted by the decryptor 42 is the digest data generated from the host data P that is the data before the cryptographic key K is embedded, and the verification hash r is also the digest data generated from the host data P′ that is the data before the cryptographic key K is embedded. Therefore, the watermark extracting apparatus 200 can detect whether there is any tampering to the host data or not by comparing these two hashes, since there is no influence of the watermark upon the hashes.

According to the watermark embedding apparatus 100 in this embodiment, the operations of the watermark embedder 30 and the hash generator 32 can be executed in parallel, resulting in the high speed of the processing. Moreover, if the watermark has been embedded by a reversible watermarking scheme, the hash can be calculated by using all the data included in the host data P. Therefore this scheme can achieve a higher accuracy of the tamper detection by the hash thus calculated than the scheme in which a part of the area or a couple of the bit planes of the host data P are used as the area to be watermarked.

### Embodiment 4

A tamper detection system according to Embodiment 4 also includes a watermark embedding apparatus 100 and a watermark extracting apparatus 200 as in Embodiment 1, however, unlike Embodiment 1, the host data input to the watermark embedding apparatus 100 and the signature-attached key-embedded host data input to the watermark extracting apparatus 200 is time series data such as a moving image, an audio or the like and the digital signatures therein are correlated in a temporal direction.

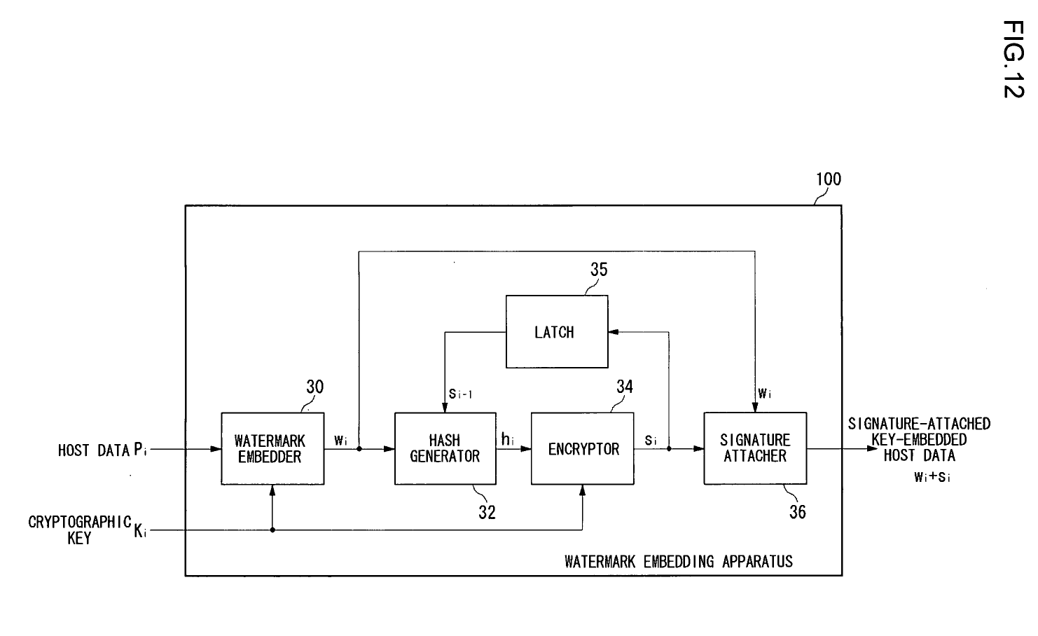

FIG. 12 shows a structure of the watermark embedding apparatus 100 according to Embodiment 4. The host data Pᵢ input to the watermark embedding apparatus 100 is one unit of time series host data, and by this unit the digital signature is attached and the digital watermark is embedded. The unit processed by this watermark embedding apparatus 100 is, for instance, a frame in the case of a moving image, and a block divided by every predetermined number of samples in the case of an audio.

The watermark embedder 30 embeds the cryptographic key Kᵢ as a digital watermark into the host data Pᵢ that is the i-th processing unit of the time series host data so as to generate the key-embedded host data wᵢ and provides it to the hash generator 32 and the signature attacher 36. It is to be noted that the cryptographic key Kᵢ herein differs for every one unit of the time series host data. As a matter of course, the same cryptographic key Kᵢ might be used for the entire time series host data.

The hash generator 32 reads the digital signature sᵢ₋₁ generated for the (i−1)-th host data Pᵢ₋₁ from a latch 35. The hash generator 32 generates the hash hᵢ by putting the key-embedded host data wᵢ into a one-way function in such a way that the generated hash hᵢ depends on the digital signature sᵢ₋₁, and provides the hash hᵢ to the encryptor 34. The encryptor 34 encrypts the hash hᵢ, which has been generated by the hash generator 32, with the cryptographic key Kᵢ and thereby generates the digital signature sᵢ.

The latch 35 receives an input of the digital signature sᵢ for the i-th host data Pᵢ, which has been generated by the encryptor 34, and holds the digital signature sᵢ until receiving an input of the next digital signature sᵢ₊₁ for the next (i+1)-th host data Pᵢ₊₁. The digital signature sᵢ for the i-th host data Pᵢ held by the latch 35 is used when the hash generator 32 generates the hash hᵢ₊₁ from the (i+1)-th host data Pᵢ₊₁.

By the operations of the hash generator 32, the encryptor 34 and the latch 35, the dependence of the digital signatures arises in a chain between the processing units of the time series host data in such a manner that the digital signature sᵢ for the i-th host data Pᵢ depends on the digital signature sᵢ₋₁ for the (i−1)-th host data Pᵢ₋₁ which was just previously generated. Moreover, since the cryptographic key Kᵢ differs for each processing unit, the dependence of the cryptographic keys also arises in the temporal direction.

The signature attacher 36 attaches the digital signature sᵢ generated by the encryptor 34 to the key-embedded host data wᵢ generated by the watermark embedder 30 and then outputs the signature-attached key-embedded host data wᵢ+sᵢ.

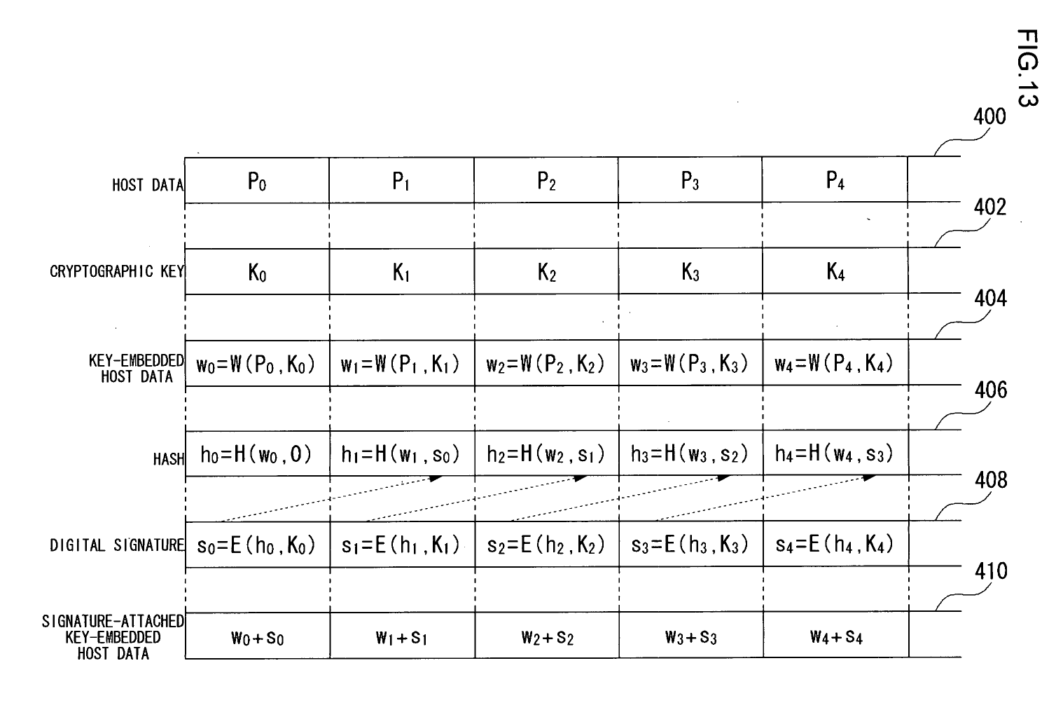

FIG. 13 illustrates how the host data Pᵢ is processed by the watermark embedding apparatus 100. For the host data P₀ to P₄ given (denoted by reference numeral 400), the figure shows the relationship between the cryptographic key K₀ to K₄, the key-embedded host data w₀ to w₄, the hash h₀ to h₄, the digital signature s₀ to s₄, and the signature-attached key-embedded host data w₀+s₀ to w₄+s₄ (denoted by reference numerals 402, 404, 406, 408, and 410 respectively).

The processing of the first host data P₀ is first described. The watermark embedder 30 converts the host data P₀ into the key-embedded host data w₀=W(P₀,K₀) by using the watermark embedding function W based on the cryptographic key K₀. The hash generator 32 converts the key-embedded host data w₀ into the hash h₀=H(w₀,0) by using the hash function H. The value of the second argument of the hash function H is herein set to be 0, however, any value other than 0 can be assigned to the second argument as long as the same hash value can be obtained in the watermark embedding apparatus 100 and the watermark extracting apparatus 200.

The encryptor 34 converts the hash h₀ into the digital signature s₀=E(h₀,K₀) by using the encryption function E based on the cryptographic key K₀. The signature attacher 36 generates the signature-attached key-embedded host data w₀+s₀ in which the digital signature s₀ is provided as a header of the key-embedded host data w₀.

When the next host data P₁ is given, the watermark embedder 30 converts the host data P₁ into the key-embedded host data w₁=W(P₁,K₁) by using the watermark embedding function W based on the cryptographic key K₁. The hash generator 32 converts the key-embedded host data w₁ into the hash h₁=H(w₁,s₀) by the hash function H using the digital signature s₀ generated for the one-step previous host data P₀. The second argument of the hash function H is the digital signature s₀ for the one-step previous host data P₀ and the hash calculation is performed in such a manner that the hash value depends on the digital signature s₀.

The encryptor 34 converts the hash h₁ into the digital signature s₁=E(h₁,K₁) by the encryption function E based on the cryptographic key K₁. Since the hash h₁ depends on the digital signature s₀ for the one-step previous host data P₀, the digital signature s₁ thus generated by encrypting the hash h₁ becomes dependent on the digital signature s₀ for the one-step previous host data P₀. Moreover, since the digital signature s₀ for the one-step previous host data P₀ depends on the one-step previous cryptographic key K₀, the digital signature s₁ thus generated for the current host data P₁ becomes dependent on not only the present cryptographic key K₁ but also the one-step previous cryptographic key K₀. The signature attacher 36 generates the signature-attached key-embedded host data w₁+s₁ in which the digital signature s₁ is provided as a header of the key-embedded host data w₁.

Thereafter, the subsequent host data P₂ to P₄ are processed in a similar manner.

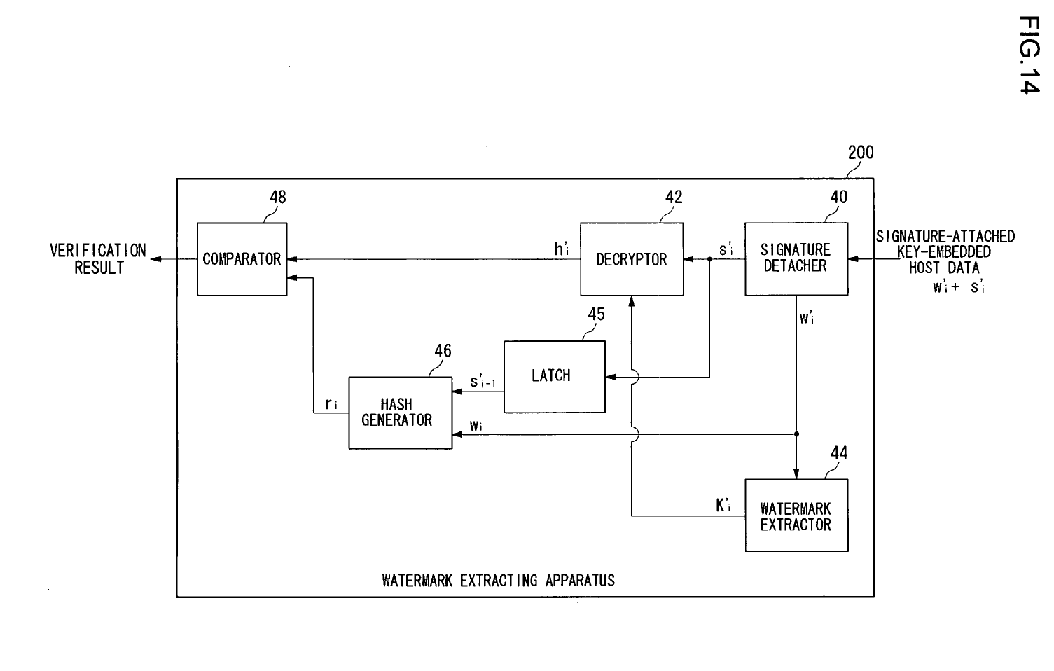

FIG. 14 shows a structure of the watermark extracting apparatus 200 according to Embodiment 4. The signature detacher 40 takes the key-embedded host data wᵢ′ and the digital signature sᵢ′ out of the input signature-attached key-embedded host data wᵢ′+sᵢ′, and provides the key-embedded host data wᵢ′ to the watermark extractor 44 and the hash generator 46 and the digital signatures sᵢ′ to the decryptor 42 and the latch 45.

The watermark extractor 44 extracts the cryptographic key Kᵢ′ which has been embedded as a digital watermark into the key-embedded host data wᵢ′ and provides the extracted cryptographic key Kᵢ′ to the decryptor 42. The decryptor 42 decrypts the digital signature sᵢ′ with the cryptographic key Kᵢ′ and thereby obtains the hash hᵢ′ that is the data before the digital signature sᵢ′ is encrypted.

On the other hand, the hash generator 46 reads from the latch 45 the digital signature sᵢ₋₁′ included in the (i−1)-th signature-attached key-embedded host data wᵢ₋₁′+sᵢ₋₁′. The hash generator 46 generates the verification hash rᵢ by putting the key-embedded host data wᵢ′ into a one-way function in such a manner that the hash rᵢ depends on the digital signature sᵢ₋₁′.

The comparator 48 compares the hash hᵢ′ decrypted by the decryptor 42 with the verification hash rᵢ generated by the hash generator 46, and then outputs the verification result concerning whether there is any tampering to the host data or not.

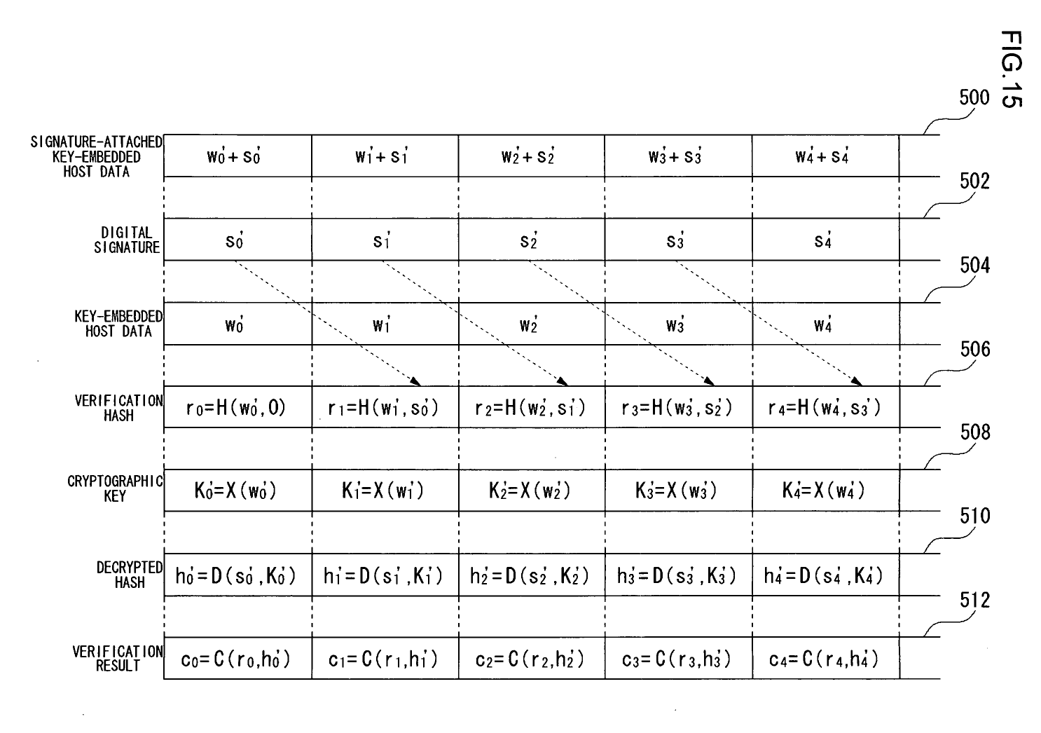

FIG. 15 illustrates how the signature-attached key-embedded host data wᵢ′+sᵢ′ is processed by the watermark extracting apparatus 200. For the signature-attached key-embedded host data w₀′+s₀′ to w₄′+s₄′ given (denoted by reference numeral 500), the figure shows the relationship between the digital signature s₀′ to s₄′, the key-embedded host data w₀′ to w₄′, and the verification hash r₀ to r₄, the cryptographic key K₀′ to K₄′, the decoded hash h₀′ to h₄′, and the verification result c₀ to c₄ (denoted by reference numerals 502, 504, 506, 508, 510 and 512 respectively).

The processing of the first signature-attached key-embedded host data w₀′+s₀′ is first described. The signature detacher 40 takes the digital signature s₀′ and the key-embedded host data w₀′ out of the signature-attached key-embedded host data w₀′+s₀′. The hash generator 46 converts the key-embedded host data w₀′ into the verification hash r₀=H(w₀′,0) by using the hash function H. The second argument of the hash function H is set to be 0, because the first signature-attached key-embedded host data w₀′+s₀′ is herein being processed.

The watermark extractor 44 extracts the cryptographic key K₀′=X(w₀′) from the key-embedded host data w₀′ by using the watermark extraction function X. The decryptor 42 converts the digital signature s₀′ into the hash h₀′=D(s₀′,K₀′) by the decrypting function D based on the cryptographic key K₀′. The comparator 48 compares the decoded hash h₀′ with the verification hash r₀.

When the next signature-attached key-embedded host data w₁′+s₁′ is given, the signature detacher 40 takes the digital signature s₁′ and key-embedded host data w₁′ separately out of the signature-attached key-embedded host data w₁′+s₁′. The hash generator 46 converts the key-embedded host data w₁′ into the verification hash r₁=H(w₁′,s₀′) by the hash function H using the digital signature s₀′ taken out of the one-step previous signature-attached key-embedded host data w₀′+s₀′. The second argument of the hash function H is herein the digital signature s₀′ taken out of the one-step previous signature-attached key-embedded host data w₀′+s₀′ and the hash calculation is performed in such a manner that the hash value depends on the digital signature s₀′.

The watermark extractor 44 extracts the cryptographic key K₁′=X(w₁′) from the key-embedded host data w₁′ by using the watermark extraction function X. The decryptor 42 converts the digital signature s₁′ into the hash h₁′=D(s₁′,K₁′) by using the decrypting function D based on the cryptographic key K₁′. The comparator 48 compares the decoded hash h₁′ with the verification hash r₁.

Thereafter, the subsequent signature-attached key-embedded host data w₂′+s₂′ to w₄′+s₄′ are processed in a similar manner.

According to the tamper detection system in this embodiment, the dependence of the digital signatures arises in a chain in the temporal direction of the time series host data such that the digital signature sᵢ generated for the host data Pᵢ in the watermark embedding apparatus 100 depends on the digital signature sᵢ₋₁ for the one-step previous host data Pᵢ₋₁. If there is any tampering to the moving image such as frame insertion, deletion, replacement or the like, the dependence therebetween will collapse and the verification hash will not be generated correctly in the watermark extracting apparatus 200. Therefore, the system can detect the tampering. The watermark embedding apparatus 100 and the watermark extracting apparatus 200 in this embodiment might be applied to a surveillance camera to be used for the tamper detection for each image frame.

The processing unit of the time series host data processed by the watermark embedding apparatus 100 and the watermark extracting apparatus 200 may be a group of frames of a moving image. For instance, GOP (Group Of Picture) that is a group of pictures in the MPEG2 (Moving Picture Experts Group 2) standard could be one processing unit. In the MPEG4 standard, the time series of a video-object is called VO (Video Object) and each image that composes VO is called VOP (Video Object Plane). VOP corresponds to a picture in MPEG2. The group of VOP is treated as GOV (Group Of VOP) in MPEG4, and this GOV could be one processing unit by the watermark embedding apparatus 100. In this case, the tamper can be detected by this processing unit by using the common cryptographic key Kᵢ and digital signature sᵢ for each processing unit such as GOP or GOV.

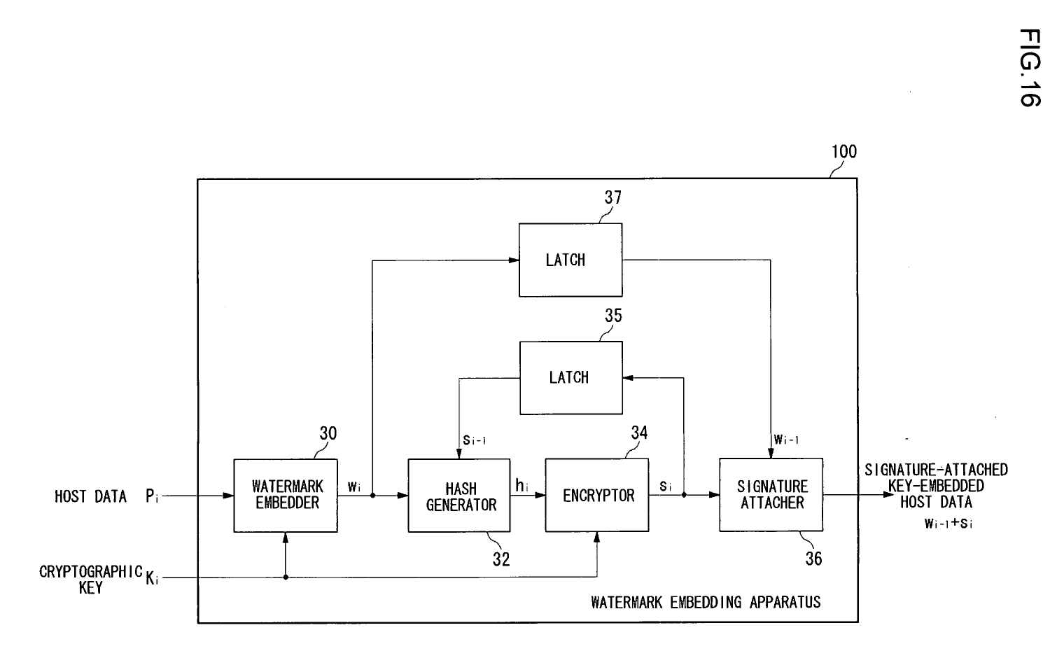

In the above description, the watermark embedding apparatus 100 performs the hash calculation such that the digital signature sᵢ generated for the host data Pᵢ depends only on the digital signature sᵢ₋₁ for the one-step previous host data Pᵢ₋₁. This hash calculation might be performed such that the digital signature sᵢ depends on a digital signature for the two-step or more previous host data, or the digital signature depends on the digital signatures for the other two or more host data. The dependency in the temporal direction can be produced in the hash calculation by using various information related to the previous or the subsequent host data. Hereinafter, some variations of the hash calculation is exemplified with reference to FIG. 16 to FIG. 21.

FIG. 16 shows a structure of another type of the watermark embedding apparatus 100 in which the next host data is used for the hash calculation. This type of the watermark embedding apparatus 100, like the watermark embedding apparatus 100 of FIG. 12, has the same latch 35 which holds the one-step previous digital signature generated by the encryptor 34 to provide the held data to the hash generator 32, however, the different point is that this type of the apparatus has another latch 37 which holds the one-step previous key-embedded host data generated by the watermark embedder 30 to provide the held data to the signature attacher 36. Only the structure and operation different from the watermark embedding apparatus 100 of FIG. 12 are now described.

The latch 37 receives an input of the i-th key-embedded host data wᵢ generated by the watermark embedder 30, and holds the key-embedded host data wᵢ until receiving an input of the next (i+1)-th key-embedded host data wᵢ₊₁.

The signature attacher 36 reads the (i−1)-th key-embedded host data wᵢ₋₁ from the latch 37 and attaches the digital signature sᵢ generated by the encryptor 34 to the key-embedded host data wᵢ₋₁, and then outputs the signature-attached key-embedded host data wᵢ₋₁+sᵢ.

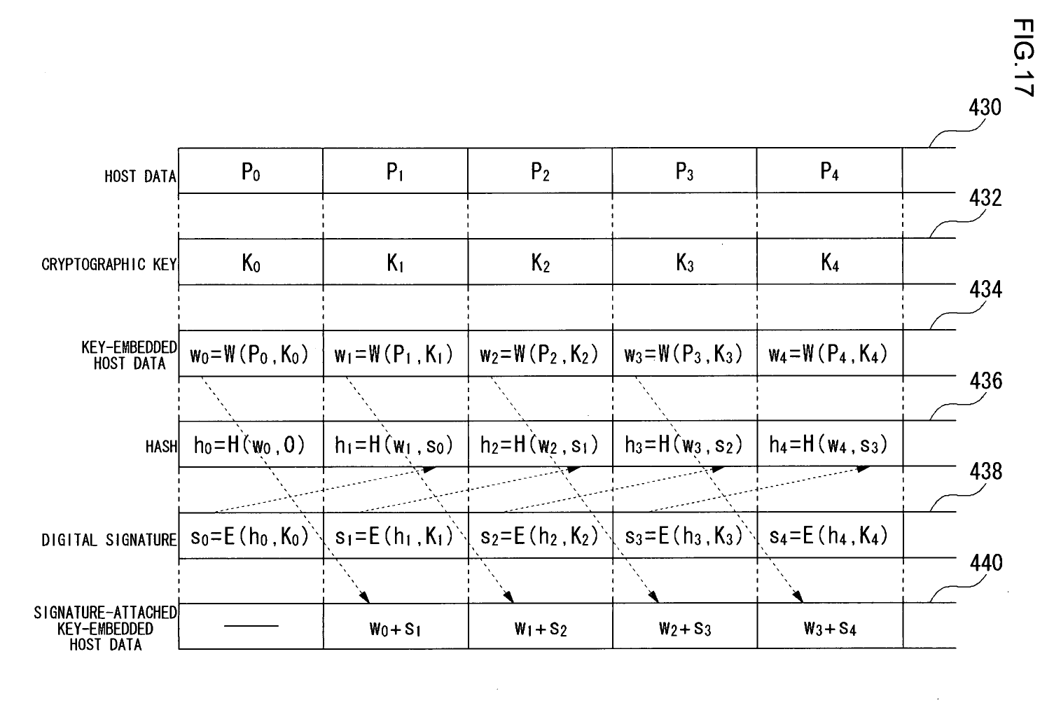

FIG. 17 illustrates how the host data Pᵢ is processed by the watermark embedding apparatus 100 of FIG. 16. For the host data P₀ to P₄ given (denoted by reference numeral 430), the figure shows the relationship between the cryptographic key K₀ to K₄, the key-embedded host data w₀ to w₄, the hash h₀ to h₄, the digital signature s₀ to s₄, and the signature-attached key-embedded host data w₀+s₁ to w₃+s₄ (denoted by reference numerals 432, 434, 436, 438, and 440 respectively). The processing of the signature-attached key-embedded host data w₀+s₁ to w₃+s₄ denoted by the last reference numeral 440 only differs from the processing described in FIG. 13.

The key-embedded host data w₀ generated based on the first host data P₀ is held until the time when the next host data P₁ is processed. In the process of the next host data P₁, the signature attacher 36 attaches the digital signature s₁ generated for the next host data P₁ to the header of the first key-embedded host data w₀, and thereby generates the first signature-attached key-embedded host data w₀+s₁.

The digital signature s₁ attached to the first key-embedded host data w₀ is one generated by using the next key-embedded host data w₁ in the hash calculation, and at the same time the signature s₁ is generated in such a manner that it depends on the digital signature s₀ for the first host data P₀. Therefore, the dependence arises in a chain between the processing units of the time series host data. Thereafter, the subsequent host data P₁ to P₄ are processed in a similar manner.

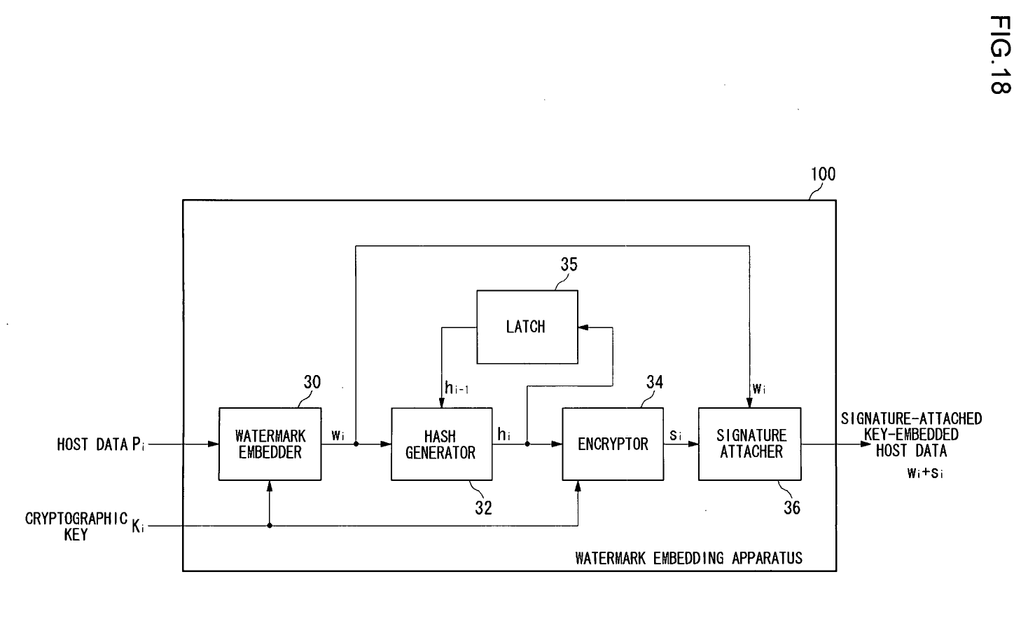

FIG. 18 shows a structure of still another type of the watermark embedding apparatus 100 which performs the hash calculation in such a manner that the output hash value depends on the hash value of the past host data instead of depending on the digital signature for the past host data. The latch 35 of the watermark embedding apparatus 100 of FIG. 12 holds the one-step previous digital signature generated by the encryptor 34 and provides the held data to the hash generator 32, however, the latch 35 of this type of the watermark embedding apparatus 100 holds the one-step previous hash value generated by the hash generator 32 and provides the held data to the hash generator 32. Only the structure and operation different from the watermark embedding apparatus 100 of FIG. 12 are now described.

The latch 35 receives an input of the i-th hash hᵢ generated by the hash generator 32, and holds the hash hᵢ until receiving an input of the next (i+1)-th hash hᵢ₊₁.

The hash generator 32 reads the (i−1)-th hash hᵢ₋₁ from the latch 35, and generates the hash hᵢ by putting the key-embedded host data wᵢ into a one-way function in such a manner that the output hash hᵢ depends on the (i−1)-th hash hᵢ₋₁, and then provides the generated hash hᵢ to the encryptor 34.

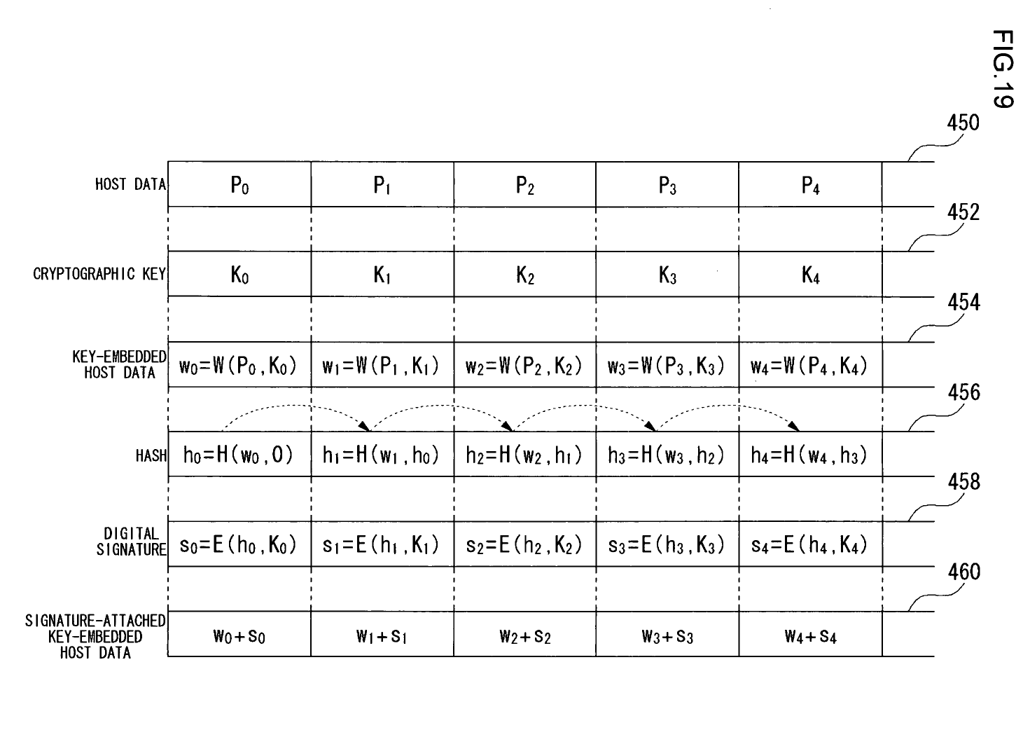

FIG. 19 illustrates how the host data Pᵢ is processed by the watermark embedding apparatus 100 of FIG. 18. For the host data P₀ to P₄ given (denoted by reference numeral 450), the figure shows the relationship between the cryptographic keys K₀ to K₄, the key-embedded host data w₀ to w₄, the hashes h₀ to h₄, the digital signatures s₀ to s₄, and the signature-attached key-embedded host data w₀+s₀ to w₄+s₄ (denoted by reference numerals 452, 454, 456, 458 and 460 respectively). The processing of the hashes h₀ to h₄ denoted by reference numeral 456 only differs from the processing described in FIG. 13.

The hash h₀ generated for the first host data P₀ is held until the time when the next host data P₁ is processed. In the process of the next host data P₁, the hash generator 32 converts the key-embedded host data w₁ into the hash h₁=H(w₁,h₀) by the hash function H using the hash h₀ for the one-step previous host data P₀. The second argument of the hash function H is the hash h₀ for the one-step previous host data P₀ and the hash calculation is performed for the current host data P₁ in such a manner that the output hash value depends on the hash h₀.

Thereafter, the subsequent host data P₂ to P₄ are processed in a similar manner. As a result, the dependence arises in a chain between the processing units of the time series host data such that the digital signature sᵢ for the i-th host data Pᵢ depends on not only the hash hᵢ for the i-th host data Pᵢ but also the hash hᵢ₋₁ for the one-step previous (i−1)-th host data Pᵢ₋₁.

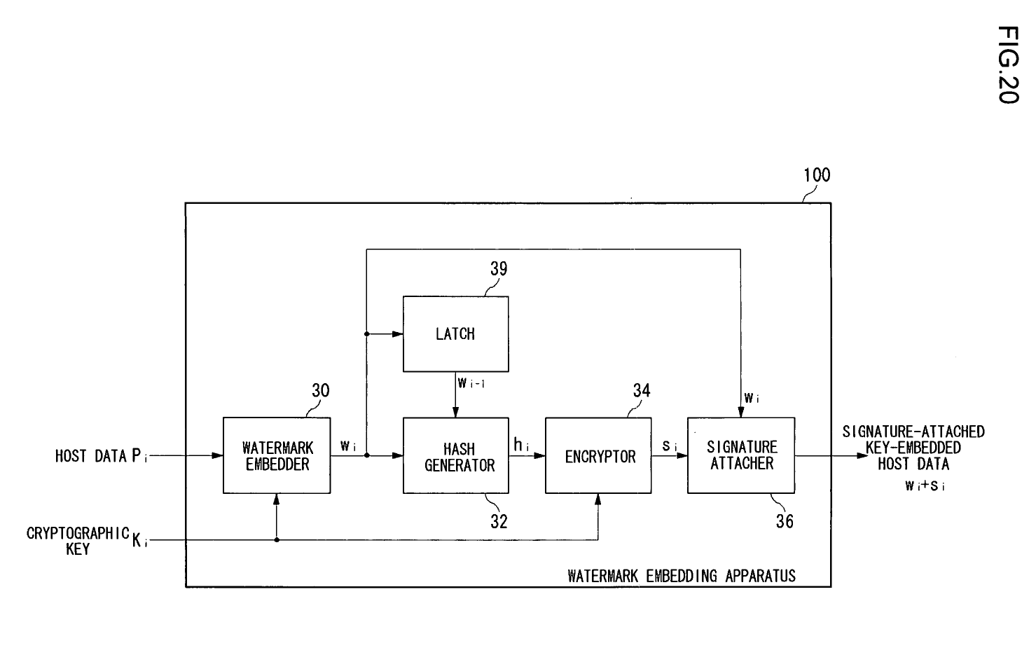

FIG. 20 shows a structure of still another type of the watermark embedding apparatus 100 which performs the hash calculation in such a manner that the hash value depends on the entire past host data instead of depending on the digital signature for the past host data. In place of the latch 35 in the watermark embedding apparatus 100 of FIG. 12, this type of the watermark embedding apparatus 100 includes a latch 39 which holds the one-step previous key-embedded host data generated by the watermark embedder 30 and provides the held data to the hash generator 32. Only the structure and operation different from the watermark embedding apparatus 100 of FIG. 12 are now described.

The latch 39 receives an input of the i-th key-embedded host data wᵢ generated by the watermark embedder 30 and holds the key-embedded host data wᵢ until receiving an input of the next (i+1)-th key-embedded host data wᵢ₊₁.

The hash generator 32 reads the (i−1)-th key-embedded host data wᵢ₋₁ from the latch 39, and generates the hash hᵢ by putting the key-embedded host data wᵢ into a one-way function in such a manner that the output hash value depends on the key-embedded host data wᵢ₋₁, and then provides the generated hash hᵢ to the encryptor 34.

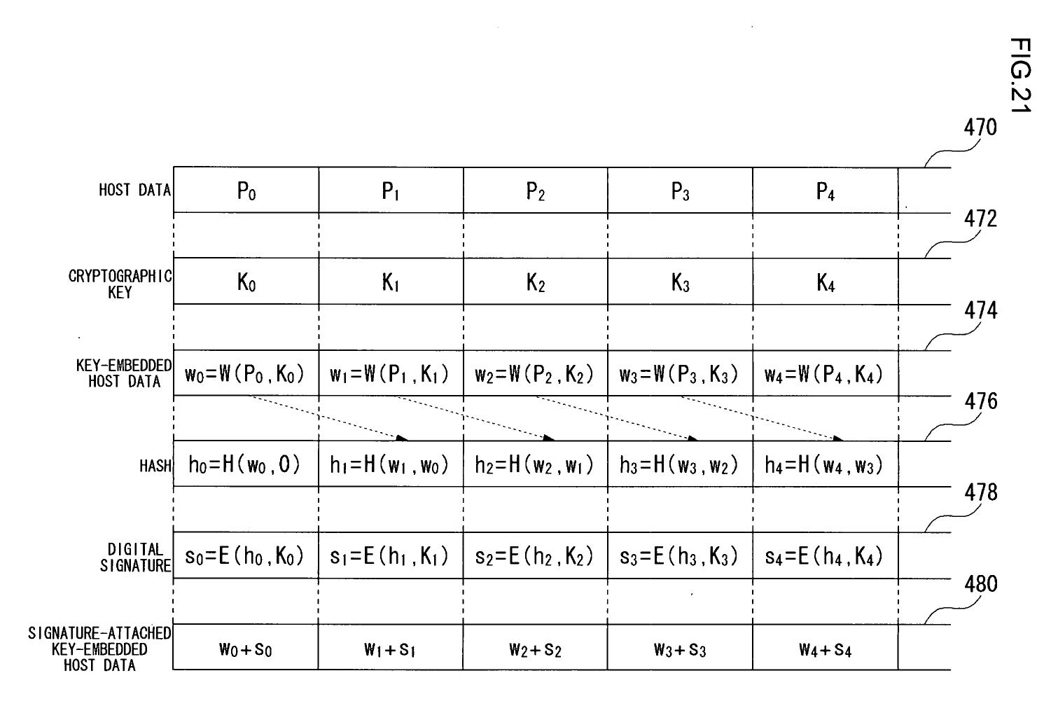

FIG. 21 illustrates how the host data Pᵢ is processed by the watermark embedding apparatus 100 of FIG. 20. For the host data P₀ to P₄ given (denoted by reference numeral 470), the figure shows the relationship between the cryptographic keys K₀ to K₄, the key-embedded host data w₀ to w₄, the hashes h₀ to h₄, the digital signature s₀ to s₄, and the signature-attached key-embedded host data w₀+s₀ to w₄+s₄ (denoted by reference numerals 472, 474, 476, 478, and 480 respectively). The processing of the hashes h₀ to h₄ denoted by reference numeral 476 only differs from the processing described in FIG. 13.

The key-embedded host data w₀ generated for the first host data P₀ is held until the time when the next host data P₁ is processed. In the process of the next host data P₁, the hash generator 32 converts the key-embedded host data w₁ into the hash h₁=H(w₁,w₀) by the hash function H using the one-step previous key-embedded host data w₀. The second argument of the hash function H is the one-step previous key-embedded host data w₀ and the hash calculation is performed for the current host data P₁ in such a manner that the output hash value depends on the key-embedded host data w₀.

Thereafter, the subsequent host data P₂ to P₄ are processed in a similar manner. As a result, the dependence arises in a chain between the processing units of the time series host data such that the digital signature sᵢ for the i-th host data Pᵢ depends on not only the i-th key-embedded host data wᵢ but also the one-step previous (i−1)-th key-embedded host data wᵢ₋₁.

The structure of the watermark embedding apparatus 100 in Embodiment 3 may be applied to any type of the watermark embedding apparatus 100 in this embodiment and the hash generator 32 may calculate the hash from the host data Pᵢ in which the cryptographic key Kᵢ has not been embedded yet. In this case, if data at one time in the time series data is used for the watermarking and data at another time is used for the hash calculation, the problem of the interference between the watermark and the hash described in Embodiment 3 can be avoided.

### Embodiment 5

A tamper detection system according to Embodiment 5 correlates the digital signatures in the temporal direction for the time series data given as in Embodiment 4, but the hash function for generating the digital signature differs from that of Embodiment 4. The structure and operation different from Embodiment 4 are now described.

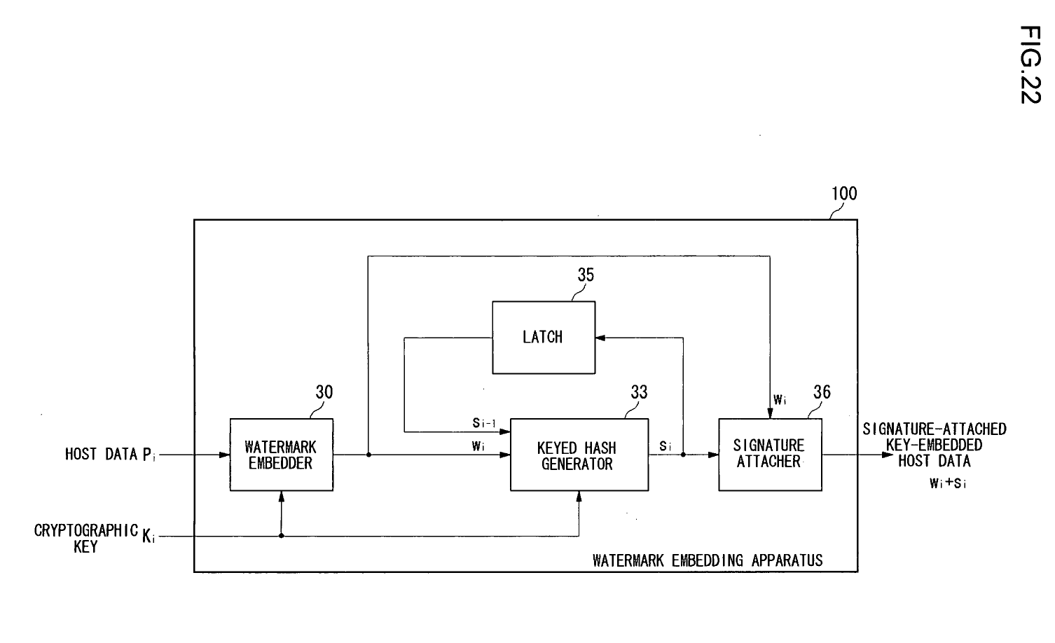

FIG. 22 shows a structure of the watermark embedding apparatus 100 according to Embodiment 5. In the watermark embedding apparatus 100 in Embodiment 4, the hash generator 32 generates the hash hᵢ from the key-embedded host data wᵢ and thereafter the encryptor 34 encrypts the hash hᵢ with the cryptographic key Kᵢ so as to generate the digital signature sᵢ. However, in the watermark embedding apparatus 100 in this embodiment, a keyed hash generator 33 performs the entire generation process of this digital signature sᵢ.

The keyed hash generator 33 reads the digital signature sᵢ₋₁ generated for the (i−1)-th host data Pᵢ₋₁ from the latch 35. Then the keyed hash generator 33 generates the digital signature sᵢ by putting the key-embedded host data wᵢ into a one-way function based on the cryptographic key Kᵢ in such a manner that the output hash value depends on the digital signature sᵢ₋₁ and provides the generated signature sᵢ to the signature attacher 36. The one-way function used by the keyed hash generator 33 is the one based on the cryptographic key and it converts an input message into an encrypted hash value. If the cryptographic key is different, a different hash value is produced even for the same input message. This hash value is referred to as MAC (Message Authentication Code).

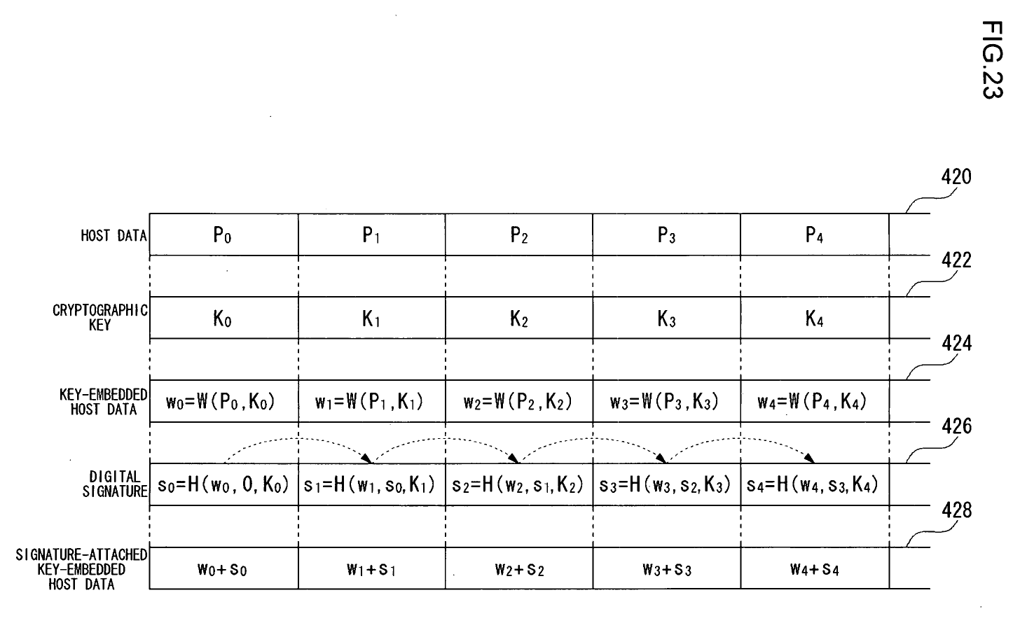

FIG. 23 illustrates how the host data Pᵢ is processed by the watermark embedding apparatus 100. For the host data P₀ to P₄ given (denoted by reference numeral 420), the figure shows the relationship between the cryptographic key K₀ to K₄, the key-embedded host data w₀ to w₄, the digital signatures s₀ to s₄, and the signature-attached key-embedded host data w₀+s₀ to w₄+s₄ (denoted by reference numerals 422, 424, 426, and 428 respectively).

The processing of the first host data P₀ is first described. The watermark embedder 30 converts the host data P₀ into the key-embedded host data w₀=W(P₀,K₀) by the watermark embedding function W based on the cryptographic key K₀. The keyed hash generator 33 converts the key-embedded host data w₀ into the digital signature s₀=H(w₀,0,K₀) by a keyed hash function H. The second argument of the keyed hash function H is 0, because the first host data P₀ is being processed herein.

The signature attacher 36 generates the signature-attached key-embedded host data w₀+s₀ in which the digital signature s₀ is provided as a header of the key-embedded host data w₀.

When the next host data P₁ is given, the watermark embedder 30 converts the host data P₁ into the key-embedded host data w₁=W(P₁,K₁) by the watermark embedding function W based on the cryptographic key K₁. The keyed hash generator 33 converts the key-embedded host data w₁ into the digital signature s₁=H(w₁,s₀,K₁) by the keyed hash function H using the digital signature s₀ generated for the one-step previous host data P₀. The second argument of the keyed hash function H is the digital signature s₀ for the one-step previous host data P₀ and the hash calculation is performed in such a manner that the output hash value depends on the digital signature s₀.

The keyed hash function H herein may be the one which performs the hash calculation for the data w₁+K₁ in which the cryptographic key K₁ is combined with the key-embedded host data w₁. Namely, the digital signature s₁ may be obtained by s₁=H(w₁+K₁, s₀). The process of combining the cryptographic key K₁ with the key-embedded host data w₁ is, for instance, conducted by attaching the cryptographic key K₁ to the end or the head of the key-embedded host data w₁.

The signature attacher 36 generates the signature-attached key-embedded host data w₁+s₁ in which the digital signature sᵢ is provided as a header of the key-embedded host data w₁.

Thereafter, the subsequent host data P₂ to P₄ are processed in a similar manner.

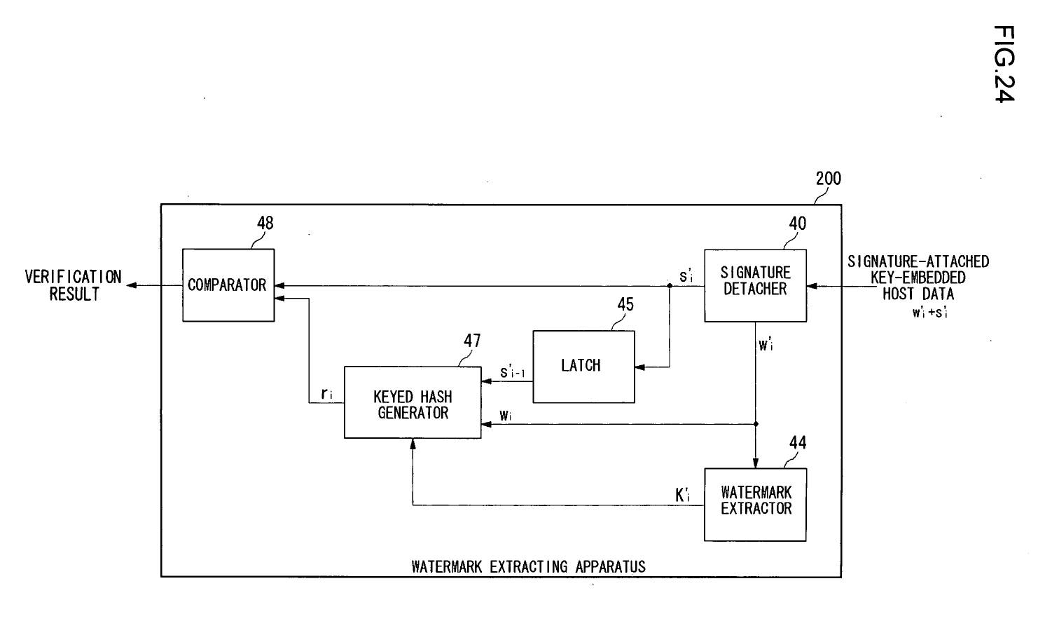

FIG. 24 shows a structure of the watermark extracting apparatus 200 according to Embodiment 5. The signature detacher 40 takes the key-embedded host data wᵢ′ and the digital signature sᵢ′ separately out of the input signature-attached key-embedded host data wᵢ′+sᵢ′, and then provides the key-embedded host data wᵢ′ to the watermark extractor 44 and the keyed hash generator 47, and the digital signatures sᵢ′ to the comparator 48 and the latch 45.

The watermark extractor 44 extracts the cryptographic key Kᵢ′ which has been embedded as a digital watermark in the key-embedded host data wᵢ′, and provides the extracted cryptographic key Kᵢ′ to the keyed hash generator 47. The keyed hash generator 47 reads the digital signature sᵢ₋₁′, which has been included in the (i−1)-th signature-attached key-embedded host data wᵢ₋₁′+sᵢ₋₁′, from the latch 45, and generates the verification signature rᵢ by putting the key-embedded host data wᵢ′ into a one-way function based on the cryptographic key Kᵢ′ in such a manner that the output hash value depends on the digital signature sᵢ₋₁′.

The comparator 48 compares the digital signature sᵢ′ taken out by the signature detacher 40 with the verification signature rᵢ generated by the keyed hash generator 47, and then outputs the verification result concerning whether there is any tampering to the host data or not.

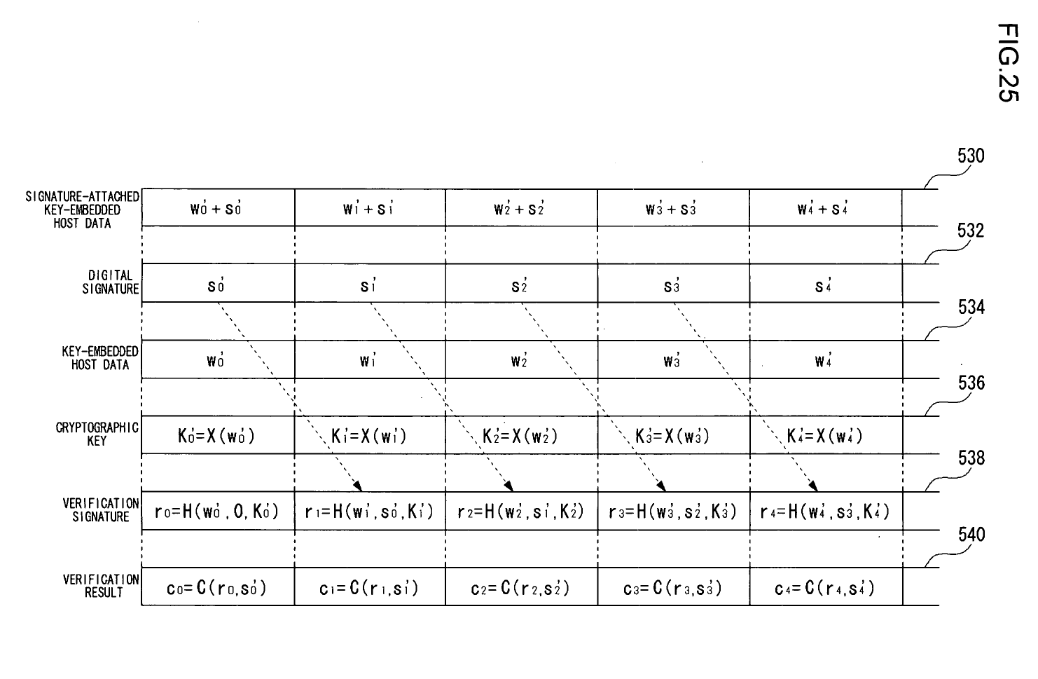

FIG. 25 illustrates how the signature-attached key-embedded host data wᵢ′+sᵢ′ is processed by the watermark extracting apparatus 200. For the signature-attached key-embedded host data w₀′+s₀′ to w₄′+s₄′ given (denoted by reference numeral 530), the figure shows the relationship between the digital signatures s₀′ to s₄′, the key-embedded host data w₀′ to w₄′, the cryptographic keys K₀′ to K₄′, the verification digital signatures for r₀ to r₄, and the verification results c₀ to c₄ (denoted by reference numerals 532, 534, 536, 538, and 540 respectively).

The processing of the first signature-attached key-embedded host data w₀′+s₀′ is first described. The signature detacher 40 takes the digital signature s₀′ and the key-embedded host data w₀′ separately out of the signature-attached key-embedded host data w₀′+s₀′. The watermark extractor 44 extracts the cryptographic key K₀′=X(w₀′) from the key-embedded host data w₀′ by using the watermark extraction function X.

The keyed hash generator 47 converts the key-embedded host data w₀′ into the verification signature r₀=H(w₀′,0,K₀′) by using the keyed hash function H. The second argument of the keyed hash function H is 0, because the first signature-attached key-embedded host data w₀′+s₀′ is being processed herein. The comparator 48 compares the digital signature s₀′ taken out of the header with the verification signatures r₀.

When the next signature-attached key-embedded host data w₁′+s₁′ is given, the signature detacher 40 takes the digital signature s₁′ and the key-embedded host data w₁′ separately out of the signature-attached key-embedded host data w₁′+s₁′. The watermark extractor 44 extracts the cryptographic key K₁′=X(w₁′) from the key-embedded host data w₁′ by using the watermark extraction function X.

The keyed hash generator 47 converts the key-embedded host data w₁′ into the verification signature s₁=H(w₁′,s₀′,K₁′) by the keyed hash function H using the digital signature s₀′ taken out of the one-step previous signature-attached key-embedded host data w₀′+s₀′. The second argument of the keyed hash function H is the digital signature s₀′ taken out of the one-step previous signature-attached key-embedded host data w₀′+s₀′ and the hash calculation is performed in such a manner that the output hash value depends on the digital signature s₀′. The comparator 48 compares the digital signature s₁′ taken out of the header with the verification signatures r₁.

Thereafter, the subsequent signature-attached key-embedded host data w₂′+s₂′ to w₄′+s₄′ are processed in a similar manner.

Since the watermark embedding apparatus 100 and the watermark extracting apparatus 200 in this embodiment can obtain the digital signature for the host data by one hash operation using the keyed hash function, the processing speed can be improved.

### Embodiment 6

A tamper detection system according to Embodiment 6 is a system in which an image is encoded and decoded. The system is configured so that an image encoding apparatus 120 is incorporated into the watermark embedding apparatus 100 in Embodiment 1, and an image decoding apparatus 220 is incorporated into the watermark extracting apparatus 200 in Embodiment 1.

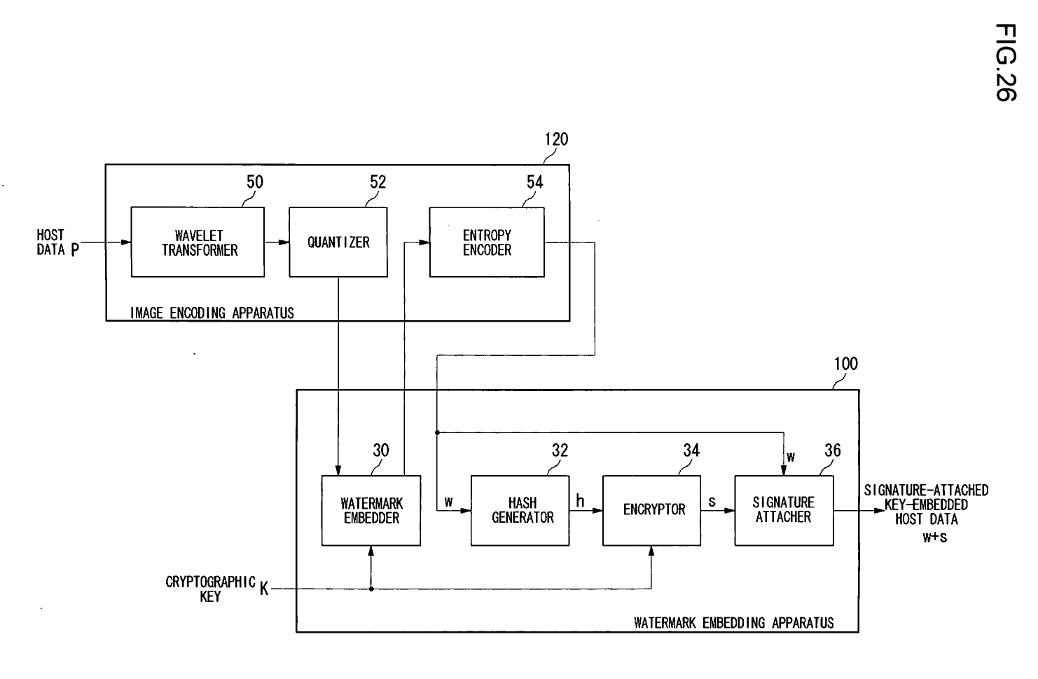

FIG. 26 shows a structure of the watermark embedding apparatus 100 into which the image encoding apparatus 120 is incorporated according to Embodiment 6. The image encoding apparatus 120 converts an image into a spatial frequency domain data, for instance, by JPEG2000 standard using a discrete wavelet transform (DWT), which is a successor of JPEG (Joint Photographic Experts Group), and then compresses the converted image.

A wavelet transformer 50 performs a wavelet transform on the input host data P and outputs wavelet transform coefficients to a quantizer 52. The quantizer 52 quantizes the wavelet transform coefficients, and provides the quantized coefficients to the watermark embedder 30 in the watermark embedding apparatus 100.

In the watermark embedding apparatus 100, the watermark embedder 30 embeds the cryptographic key K as a digital watermark into the quantized wavelet transform coefficients and provides the key-embedded wavelet transform coefficients to an entropy encoder 54 in the image encoding apparatus 120.

The entropy encoder 54 compresses the key-embedded wavelet transform coefficients losslessly and outputs the compressed key-embedded host data w to the hash generator 32 in the watermark embedding apparatus 100. The subsequent processing by the hash generator 32, the encryptor 34, and the signature attacher 36 in the watermark embedding apparatus 100 is the same as described in Embodiment 1, and the signature-attached key-embedded host data w+s is finally output from the watermark embedding apparatus 100.

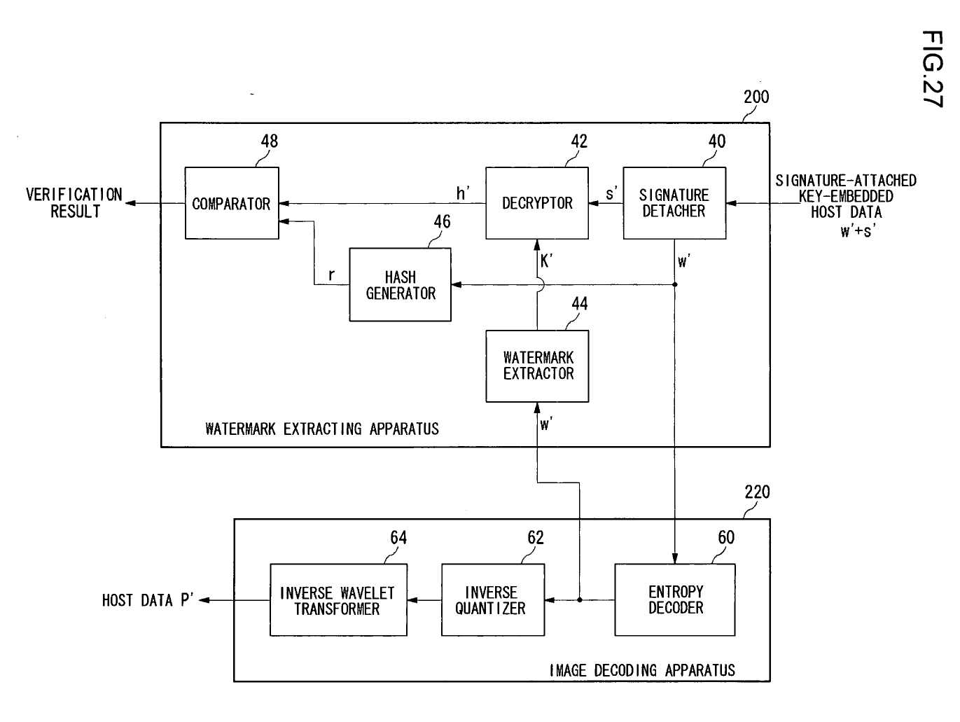

FIG. 27 shows a structure of the watermark extracting apparatus 200 into which the image decoding apparatus 220 is incorporated according to Embodiment 6. The signature detacher 40 in the watermark extracting apparatus 200 takes the key-embedded host data w′ and the digital signature s′ separately out of the input signature-attached key-embedded host data w′+s′, and then provides the key-embedded host data w′ to the hash generator 46 and the entropy decoder 60 in the image decoding apparatus 220 and the digital signatures s′ to the decryptor 42.

In the image decoding apparatus 220, an entropy decoder 60 decompresses the key-embedded host data w′ and provides the decoded key-embedded host data w′ to an inverse quantizer 62 and the watermark extractor 44 in the watermark extracting apparatus 200. The subsequent processing by the watermark extractor 44, the decryptor 42, the hash generator 46, and the comparator 48 in the watermark extracting apparatus 200 is the same as described in Embodiment 1, and the watermark extracting apparatus 200 finally outputs the verification result concerning whether there is any tampering to the host data or not.

In the image decoding apparatus 220, the inverse quantizer 62 dequantizes the decoded key-embedded host data w′ and provides the dequantized values to the inverse wavelet transformer 64. The inverse wavelet transformer 64 performs an inverse wavelet transform on the dequantized values and outputs the host data P′ thus decoded.

According to the watermark embedding apparatus 100 in this embodiment, since the cryptographic key is embedded as a digital watermark into the wavelet transform coefficients which are the host data P quantized by the quantizer 52 in the image encoding apparatus 120, the digital watermark never be corrupted or lost by this quantization. Therefore, the watermark embedder 30 in the watermark embedding apparatus 100 may embed a fragile digital watermark, which is easily subject to the quantization.

It is to be noted that the watermark embedding apparatus 100 and the watermark extracting apparatus 200 in this embodiment may be replaced by the watermark embedding apparatus 100 and the watermark extracting apparatus 200 described in Embodiments 2 to 5. If the host data P is a moving image, the image encoding apparatus 120 performs compression such as MPEG2 or MPEG4, or compresses each frame of the moving image by JPEG or the like.

### Embodiment 7

A tamper detection system according to Embodiment 7 is a system in which an image is encoded and decoded, as in Embodiment 6. The system is configured so that an image encoding apparatus 120 is incorporated into the watermark embedding apparatus 100 in Embodiment 1 and an image decoding apparatus 220 is incorporated into the watermark extracting apparatus 200 in Embodiment 1.

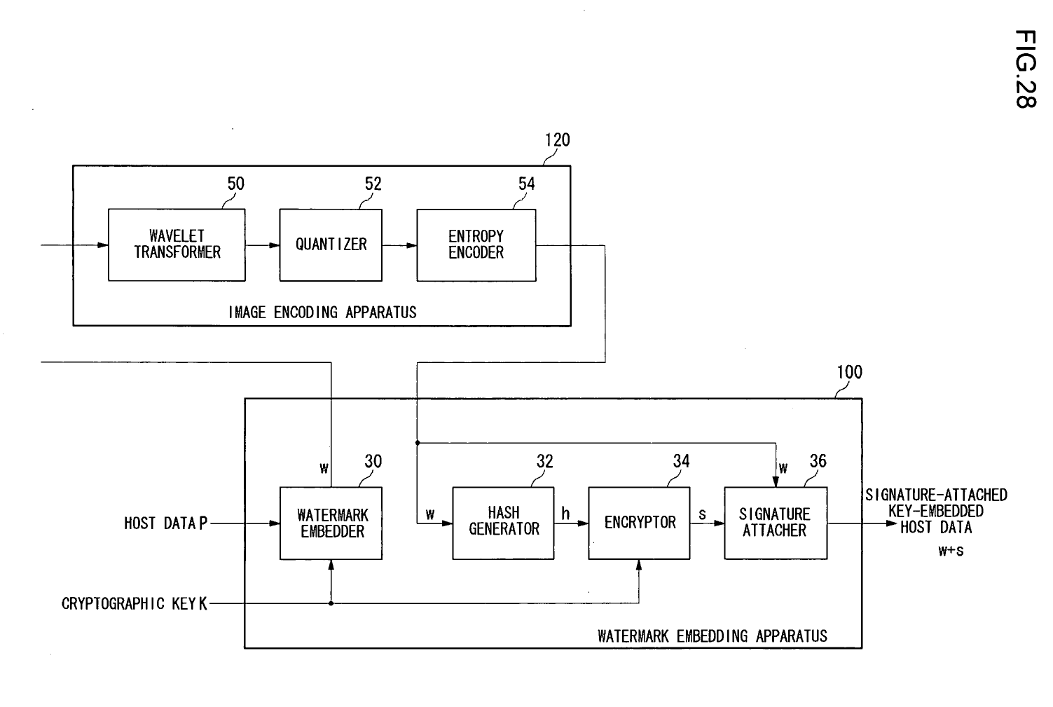

FIG. 28 shows a structure of the watermark embedding apparatus 100 into which the image encoding apparatus 120 is incorporated according to Embodiment 7. The watermark embedder 30 in the watermark embedding apparatus 100 embeds the cryptographic key K as a digital watermark into the host data P and provides the key-embedded host data w to the wavelet transformer 50 in the image encoding apparatus 120.

The wavelet transformer 50 performs a wavelet transform on the key-embedded host data w, and provides the key-embedded wavelet transform coefficients to the quantizer 52. The quantizer 52 quantizes the key-embedded wavelet transform coefficients and provides it to the entropy encoder 54.

The entropy encoder 54 compresses the key-embedded wavelet transform coefficients losslessly and provides the compressed key-embedded host data w to the hash generator 32 in the watermark embedding apparatus 100. The subsequent processing by the hash generator 32, the encryptor 34, and the signature attacher 36 in the watermark embedding apparatus 100 is the same as described in Embodiment 1, and the signature-attached key-embedded host data w+s is finally output from the watermark embedding apparatus 100.

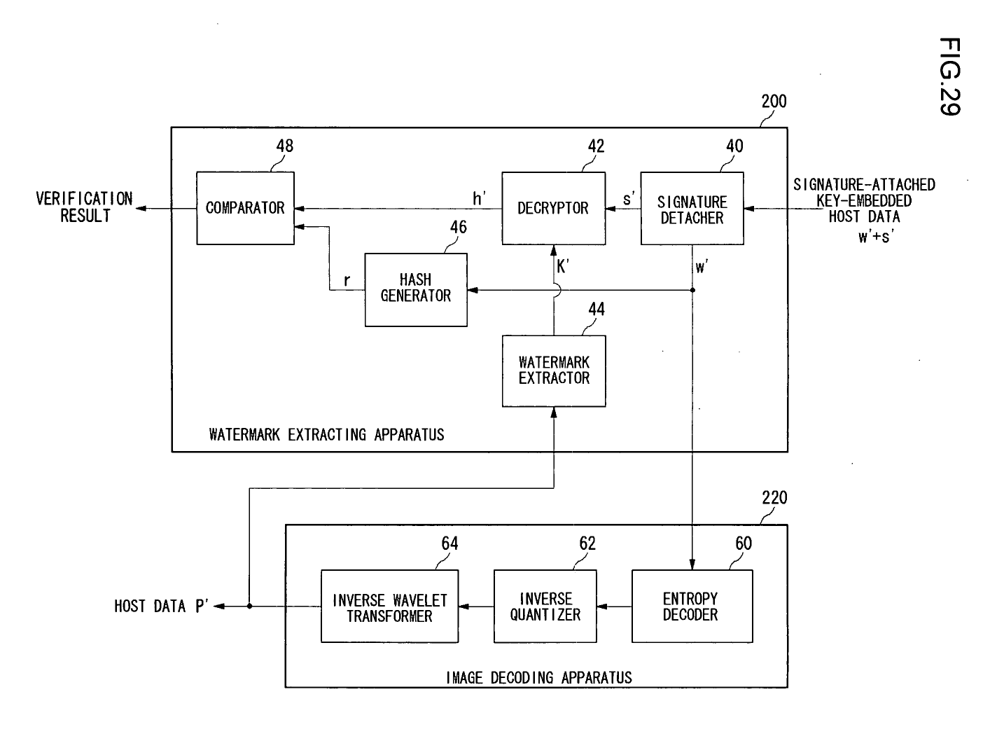

FIG. 29 shows a structure of the watermark extracting apparatus 200 into which the image decoding apparatus 220 is incorporated according to Embodiment 7. The signature detacher 40 in the watermark extracting apparatus 200 takes the key-embedded host data w′ and the digital signature s′ separately out of the input signature-attached key-embedded host data w′+s′, and then provides the key-embedded host data w′ to the hash generator 46 and the entropy decoder 60 in the image decoding apparatus 220, and the digital signatures s′ to the decryptor 42.

In the image decoding apparatus 220, the entropy decoder 60 decompresses the key-embedded host data w′ and provides the decompressed key-embedded host data w′ to the inverse quantizer 62. The inverse quantizer 62 dequantizes the decompressed key-embedded host data w′ and provides it to the inverse wavelet transformer 64. The inverse wavelet transformer 64 performs an inverse wavelet transform on the dequantized values and outputs the decoded host data P′ and also provides the decoded host data P′ to the watermark extractor 44 in the watermark extracting apparatus 200.

The subsequent processing by the watermark extractor 44, the decryptor 42, the hash generator 46, and the comparator 48 in the watermark extracting apparatus 200 is the same as described in Embodiment 1, and the watermark extracting apparatus 200 outputs the verification result concerning whether there is any tampering to the host data or not.

According to the watermark embedding apparatus 100 in this embodiment, since the cryptographic key is embedded as a digital watermark into the host data P before the host data P is quantized by the quantizer 52 in the image encoding apparatus 120, there is a possibility that the digital watermark might be corrupted in the process of the quantization. Therefore, the watermark embedder 30 in the watermark embedding apparatus 100 in this embodiment embeds a robust digital watermark, which is hardly subject to the quantization.

In this embodiment, unlike Embodiment 6, any intermediate result does not need to be obtained from the inside of the image encoding apparatus 120 and the image decoding apparatus 220 and any input does not need to be given to an internal computing unit thereof, and only the input and output of the image encoding apparatus 120 and the image decoding apparatus 220 are utilized. Therefore, the image encoding apparatus 120 and the image decoding apparatus 220 can be easily incorporated into the watermark embedding apparatus 100 and the watermark extracting apparatus 200 respectively, resulting in a simplified configuration.

Although the present invention has been described by way of exemplary embodiments, it should be understood that many changes and substitutions may be made by those skilled in the art without departing from the scope of the present invention which is defined by the appended claims.

In the description given above, the cryptographic key for encrypting the digital signature is a private key with such a symmetric property that the same key is used for encryption and decryption, however, the system may be configured by using a public key system in such a manner that the digital signature is encrypted by a private key and decrypted by a public key. In this case, a public key necessary for decrypting the digital signature is embedded in the host data as a digital watermark.

1. A digital watermark embedding apparatus comprising:
an encrypting unit which encrypts additional data to be attached to original data;
a watermark embedding unit which embeds a cryptographic key necessary for decrypting the encrypted additional data into the original data as a digital watermark; and
an attaching unit which attaches the encrypted additional data to the original data.

2. A digital watermark embedding apparatus comprising:
an encrypting unit which encrypts data briefly representing a characteristic of original data so as to generate a digital signature;
a watermark embedding unit which embeds a cryptographic key necessary for decrypting the digital signature into the original data as a digital watermark; and
a signature attaching unit which attaches the digital signature to the original data.

3. The apparatus of claim 2 further comprising a generating unit which generates the data briefly representing the characteristic of the original data by putting the original data into a one-way function.

4. A digital watermark extracting apparatus comprising:
a detaching unit which takes original data and additional data separately out of input data;
a watermark extracting unit which extracts a cryptographic key which has been embedded as a digital watermark into the original data; and
a decrypting unit which decrypts the additional data with the cryptographic key.

5. A digital watermark extracting apparatus comprising:
a signature detaching unit which takes original data and a digital signature separately out of signature-attached data;
a watermark extracting unit which extracts a cryptographic key which has been embedded as a digital watermark into the original data; and
a decrypting unit which decrypts the digital signature with the cryptographic key.

6. The apparatus of claim 5 further comprising:
a generating unit which generates data briefly representing a characteristic of the original data by putting the original data into a one-way function; and
a comparing unit which compares the digital signature decrypted by the decrypting unit with the data briefly representing the characteristic of the original data generated by the generating unit.

7. A digital watermark extracting apparatus comprising:
a signature detaching unit which takes original data and a digital signature separately out of signature-attached data;
a watermark extracting unit which extracts a cryptographic key which has been embedded as a digital watermark into the original data;
an encrypting unit which encrypts data briefly representing a characteristic of the original data with the cryptographic key so as to generate a digital signature for verification; and
a comparing unit which compares the digital signature taken out by the signature detaching unit with the digital signature for the verification generated by the encrypting unit.

8. A digital watermark embedding apparatus comprising:
an encrypting unit which encrypts data briefly representing a characteristic of each original data in a series of input original data so as to generate a digital signature;
a watermark embedding unit which embeds a cryptographic key necessary for decrypting the digital signature into the original data as a digital watermark;
a signature attaching unit which attaches the digital signature to the original data; and
a holding unit which holds the digital signature generated by the encrypting unit,
wherein the encrypting unit generates the digital signature for the original data currently processed in such a manner that the generated digital signature depends on the digital signature for the original data formerly processed which has been held in the holding unit.

9. The apparatus of claim 8, wherein the encrypting unit generates the digital signature by using a different cryptographic key for the each original data.

10. A digital watermark embedding apparatus comprising:
an encrypting unit which encrypts data briefly representing a characteristic of each original data in a series of input original data so as to generate a digital signature;
a watermark embedding unit which embeds a cryptographic key necessary for decrypting the digital signature into the original data as a digital watermark;
a signature attaching unit which attaches the digital signature to the original data;
a first holding unit which holds the digital signature generated by the encrypting unit; and
a second holding unit which holds the original data in which the digital watermark has been embedded by the watermark embedding unit,
wherein the encrypting unit generates the digital signature for the original data currently processed in such a manner that the generated digital signature depends on the digital signature for the original data formerly processed which has been held in the first holding unit, and the signature attaching unit attaches the digital signature generated for the original data currently processed to the original data formerly processed which has been held in the second holding unit.

11. The apparatus of claim 10, wherein the encrypting unit generates the digital signature by using a different cryptographic key for the each original data.

12. A digital watermark extracting apparatus comprising:
a signature detaching unit which receives a series of input signature-attached data and takes original data and a digital signature separately out of each signature-attached data;
a watermark extracting unit which extracts a cryptographic key that has been embedded as a digital watermark into the original data;
a decrypting unit which decrypts the digital signature, which has been taken out by the signature detaching unit, with the cryptographic key;
a generating unit which generates data briefly representing a characteristic of the original data by putting the original data into a one-way function; and
a holding unit which holds the digital signature taken out by the signature detaching unit,
wherein the generating unit generates the data briefly representing the original data currently processed in such a manner that the generated data depends on the digital signature for the original data formerly processed which has been held in the holding unit.

13. A digital watermark extracting apparatus comprising:
a signature detaching unit which receives a series of input signature-attached data and takes original data and a digital signature separately out of each signature-attached data;
a watermark extracting unit which extracts a cryptographic key that has been embedded as a digital watermark into the original data;
an encrypting unit which encrypts data briefly representing a characteristic of the original data with a cryptographic key so as to generate a digital signature for verification;
a comparing unit which compares the digital signature taken out by the signature detaching unit with the digital signature for the verification generated by the encrypting unit; and
a holding unit which holds the digital signature taken out by the signature detaching unit,
wherein the encrypting unit generates the digital signature for the verification for the original data currently processed in such a manner that the generated digital signature depends on the digital signature for the original data formerly processed which has been held in the holding unit.

14. A data structure of a self-decryptable type of data comprising original data with a header attached thereto, wherein the header of the original data contains a digital signature obtained by encrypting data briefly representing a characteristic of the original data, and a cryptographic key necessary for decrypting the digital signature is embedded as a digital watermark into the original data.

15. A data structure of a self-decryptable type of data comprising original data, wherein a digital signature obtained by encrypting data briefly representing a characteristic of the original data and a cryptographic key necessary for decrypting the digital signature are embedded as a double watermark into the original data.

16. A digital watermark embedding method comprising attaching to the original data a digital signature obtained by encrypting data briefly representing a characteristic of original data, and embedding a cryptographic key necessary for decrypting the digital signature into the original data as a digital watermark.

17. A digital watermark extracting method comprising extracting a cryptographic key which has been embedded as a digital watermark into original data, and decrypting a digital signature attached to the original data with the cryptographic key so as to verify the digital signature.
